(19) United States
(12) Patent Application Publication
(10) Pub. No.: US 2025/0224566 A1
(43) Pub. Date: Jul. 10, 2025

(54) SEMICONDUCTOR PHOTONICS DEVICE AND METHODS OF FORMATION

(71) Applicant: Taiwan Semiconductor Manufacturing Company, Ltd., Hsinchu (TW)

(72) Inventors: Chih-Tsung SHIH, Hsinchu City (TW); Sheng Kai YEH, Taichung City (TW); Chi-Yuan SHIH, Zhubei (TW)

(21) Appl. No.: 18/662,308

(22) Filed: May 13, 2024

Related U.S. Application Data
(60) Provisional application No. 63/617,926, filed on Jan. 5, 2024.

(51) Int. Cl. G02B 6/293

(52) U.S. Cl. CPC G02B 6/29343

(57) ABSTRACT

A semiconductor photonics device includes a plurality of bus optical waveguide structures and one or more closed-loop optical waveguide structures that are arranged in a cascaded photonic integrated circuit such as a cascaded resonator circuit. At least one of the closed-loop optical waveguide structures is manufactured to have a polygonal top view shape in which the closed-loop optical waveguide structure includes a plurality of segments. This enables the intrinsic loss for the closed-loop optical waveguide structure to be tuned to achieve optical loss matching in the photonic integrated circuit.

### CROSS-REFERENCE TO RELATED APPLICATION

This Patent Application claims priority to U.S. Provisional Patent Application No. 63/617,926, filed on Jan. 5, 2024, and entitled “SEMICONDUCTOR PHOTONICS DEVICES AND METHODS OF FORMATION.” The disclosure of the prior Application is considered part of and is incorporated by reference into this Patent Application.

### BACKGROUND

A semiconductor photonics device may be configured to use optical signals for high speed and secure data transmission between integrated circuits and/or semiconductor dies of the semiconductor photonics device. An optical signal may be transferred through a waveguide in the semiconductor photonics device. The waveguide enables confinement of the optical signal, which may reduce optical loss and increase propagation efficiency for the optical signal. Data may be encoded into an optical signal by modulating light into optical pulses through an optical modulator. The optical pulses are then transferred to the waveguide for propagation to other regions of the semiconductor photonics device.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIGS. 1A-1E are diagrams of example implementations of an example semiconductor photonics device described herein.

FIGS. 2A-2D are diagrams of example implementations of an example semiconductor photonics device described herein.

FIGS. 3A-3E are diagrams of example implementations of an example semiconductor photonics device described herein.

FIGS. 4A-4E are diagrams of example implementations of an example semiconductor photonics device described herein.

FIGS. 5A-5F are diagrams of an example implementation of forming a semiconductor photonics device (or a portion thereof) described herein.

FIGS. 6A-6F are diagrams of an example implementation of forming a semiconductor photonics device (or a portion thereof) described herein.

FIGS. 7A-7D are diagrams of an example implementation of forming a semiconductor photonics device (or a portion thereof) described herein.

FIGS. 8A-8D are diagrams of an example implementation of forming a semiconductor photonics device (or a portion thereof) described herein.

FIGS. 9A-9E are diagrams of an example implementation of forming a semiconductor photonics device (or a portion thereof) described herein.

FIGS. 10A-10D are diagrams of an example implementation of forming a semiconductor photonics device (or a portion thereof) described herein.

FIGS. 11A-11C are diagrams of example implementations of cross-sectional profiles for one or more waveguides structures described herein.

FIG. 12 is a flowchart of an example process associated with forming a semiconductor photonics device described herein.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In some cases, a photonic integrated circuit of a semiconductor photonics device may include one or more waveguide structures. For example, an approximately straight input/output waveguide structure (which may be referred to as a bus optical waveguide) may couple an optical signal to a ring-shaped waveguide structure, which may be used for filtering (e.g., wavelength filtering) or modulating the optical signal. In some cases, optical signal loss can occur as optical signals propagate around the ring-shaped waveguide structure, as well as when optical signals are coupled to and/or from the ring-shaped waveguide structure. Optical signal loss in a ring-shaped waveguide structure (intrinsic loss) may affect the quality factor (Q factor) of the ring-shaped waveguide structure. Optical signal loss from coupling (external coupling loss) also affects a power coupling coefficient (K value) of the ring-shaped waveguide structure. The power coupling coefficient is an indication of an efficiency of optical signal coupling between the ring-shaped waveguide structure and the bus optical waveguide. If external coupling loss (which reduces the power coupling coefficient) and intrinsic loss (which reduces the Q factor) are not controlled, the ring-shaped waveguide structure may not operate efficiently and/or may not effectively filter with high selectivity.

For example, when the external coupling loss is greater than the intrinsic loss, the ring-shaped waveguide structure and the associated input/output waveguide structure may become under-coupled, resulting in insufficient optical power transfer from the input/output waveguide structure to the ring-shape waveguide structure for modulation and/or filtering to occur. Conversely, when the intrinsic loss is greater than the external coupling loss, the ring-shaped waveguide structure and the associated input/output waveguide structure may become over-coupled, resulting in interference in the ring-shaped waveguide structure (which can cause nonlinear effects and/or other modulation defects) and excessive power consumption in the ring-shaped waveguide structure.

Some implementations described herein provide techniques and apparatuses for a semiconductor photonics device that includes a closed-loop optical waveguide structure having a top view size and/or shape that is configured to achieve a particular optical signal loss (intrinsic loss) for the closed-loop optical waveguide structure. The closed-loop optical waveguide structure may be manufactured to have a polygonal top view shape (such as an approximately octagonal top view shape or an approximately hexagonal top view shape, among other examples) in which the closed-loop optical waveguide structure includes a plurality of segments. The closed-loop optical waveguide structure may be manufactured to have a particular radius, to have a particular quantity of segments, and/or to have another attribute such that a particular optical signal loss is achieved for the closed-loop optical waveguide structure.

Manufacturing the closed-loop optical waveguide structure to have a particular optical signal loss enables the Q factor for the closed-loop optical waveguide structure to be balanced with the power coupling coefficient for the closed-loop optical waveguide structure. This enables the closed-loop optical waveguide structure to achieve critical coupling (or to achieve near-critical coupling), which is a condition where external coupling loss for the closed-loop optical waveguide structure and the optical signal loss for the closed-loop optical waveguide structure are approximately equal. At or near critical coupling, efficient operation (e.g., modulation or filtering with minimal modulation defects and reduced power consumption) and optical filtering with high selectivity can be achieved for the closed-loop optical waveguide structure, relative to over-coupling or under-coupling.

Moreover, in some implementations described herein, a semiconductor photonics device includes a plurality of bus optical waveguide structures and one or more closed-loop optical waveguide structures that are arranged in a cascaded photonic integrated circuit such as a cascaded resonator circuit. At least one of the closed-loop optical waveguide structures is manufactured to have a polygonal top view shape in which the closed-loop optical waveguide structure includes a plurality of segments. This enables the intrinsic loss for the closed-loop optical waveguide structure to be tuned to achieve optical loss matching in the photonic integrated circuit.

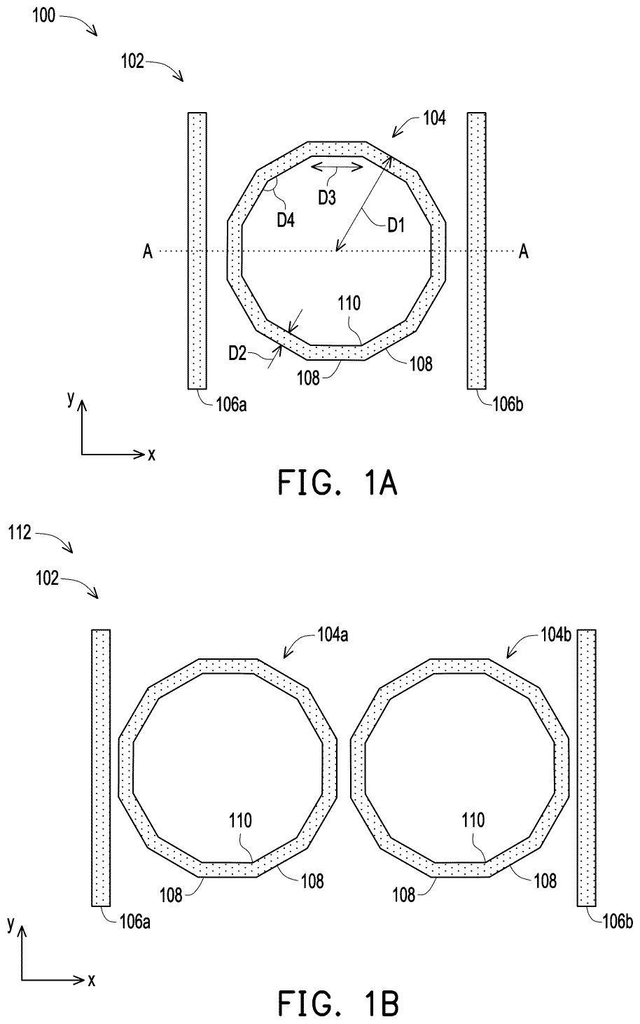

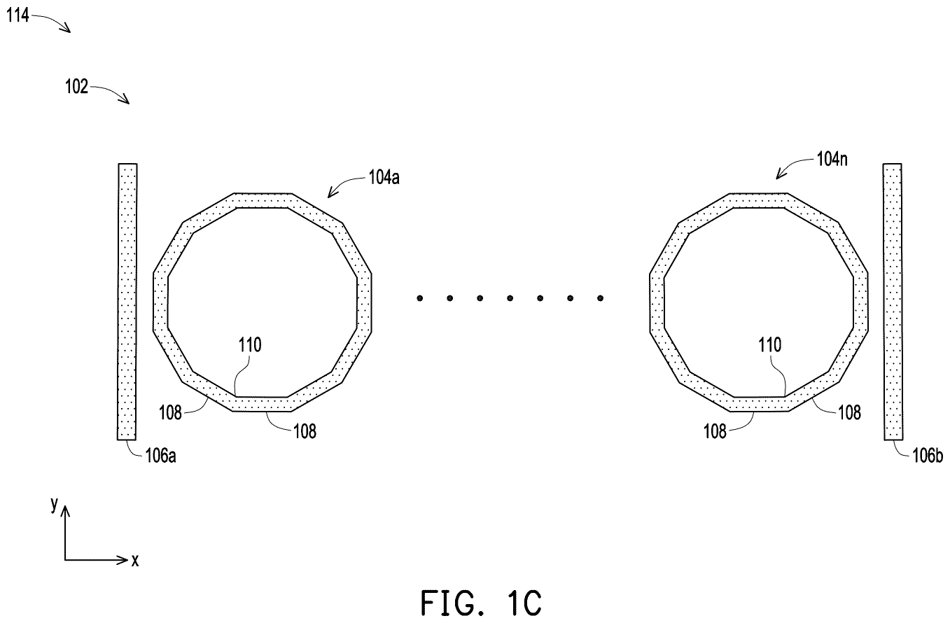

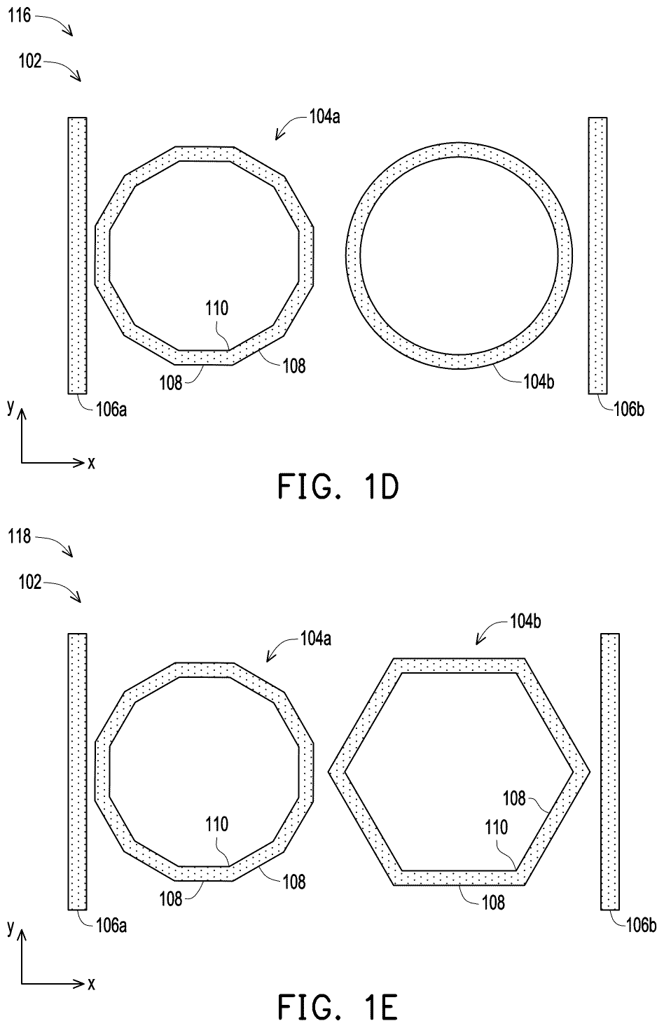

FIGS. 1A-1E are diagrams of example implementations of an example semiconductor photonics device described herein. The semiconductor photonics device includes one or more photonic integrated circuits. Each of FIGS. 1A-1E illustrates a top view of an example implementation of a semiconductor photonics device. The semiconductor photonics device may be configured to use optical signals for high speed and secure data transmission between integrated circuits and/or semiconductor dies of the semiconductor photonics device.

As shown in an example implementation 100 in FIG. 1A, a semiconductor photonics device 102 may include a closed-loop optical waveguide structure 104 and a plurality of bus optical waveguide structures 106a and 106b. The closed-loop optical waveguide structure 104 is located between the bus optical waveguide structures 106a and 106b such that the bus optical waveguide structures 106a and 106b are located adjacent to opposing sides of the closed-loop optical waveguide structure 104. The closed-loop optical waveguide structure 104 and the bus optical waveguide structures 106a and 106b are arranged in a photonic integrated circuit such as a resonator circuit or a modulator circuit, among other examples.

An optical signal may be transferred through the bus optical waveguide structure 106a in the semiconductor photonics device 102. The opposing ends of the bus optical waveguide structure 106a correspond to an input port and a through port (or output port) of the photonic integrated circuit. The bus optical waveguide structure 106a enables confinement of the optical signal, which may reduce optical loss and increase propagation efficiency for the optical signal. In some implementations, data may be encoded into an optical signal by modulating light into optical pulses in the closed-loop optical waveguide structure 104. The optical pulses are then transferred to the bus optical waveguide structure 106 for propagation to other regions of the semiconductor photonics device 102. Alternatively, particular wavelengths of the optical signal may be filtered in the closed-loop optical waveguide structure 104 such that the filtered wavelengths (or non-filtered wavelengths) are transferred back to the bus optical waveguide structure 106 for signal propagation.

The bus optical waveguide structure 106b may be used for controlling or manipulating the optical resonant properties of the closed-loop optical waveguide structure 104. For example, the opposing ends of the bus optical waveguide structure 106b may correspond to a drop port and an add port of the photonic integrated circuit. Particular wavelengths or frequencies of optical signals in the closed-loop optical waveguide structure 104 may be coupled to the bus optical waveguide structure 106b and removed through the drop port for optical signal filtering of those wavelengths or frequencies. Conversely, the add port may be used to add optical signals of particular wavelengths or frequencies of optical signals to the closed-loop optical waveguide structure 104 by coupling those optical signals from the bus optical waveguide structure 106b to the closed-loop optical waveguide structure 104.

The closed-loop optical waveguide structure 104 and the bus optical waveguide structures 106a and 106b may be adjacent and/or side by side in the semiconductor photonics device 102 to enable coupling of optical signals between the closed-loop optical waveguide structure 104 and the bus optical waveguide structures 106a and 106b. As an example, and as shown in FIG. 1A, the closed-loop optical waveguide structure 104 and the bus optical waveguide structure 106a may be horizontally adjacent (or laterally adjacent) in the x-direction in the semiconductor photonics device 102, and the closed-loop optical waveguide structure 104 and the bus optical waveguide structure 106b may be horizontally adjacent (or laterally adjacent) in the x-direction in the semiconductor photonics device 102. The bus optical waveguide structures 106a and 106b extend in the y-direction along opposing sides of the closed-loop optical waveguide structure 104. In some implementations, the distance or spacing between the closed-loop optical waveguide structure 104 and the bus optical waveguide structure 106a, and the distance or spacing between the closed-loop optical waveguide structure 104 and the bus optical waveguide structure 106b, are approximately equal. In some implementations, the distance or spacing between the closed-loop optical waveguide structure 104 and the bus optical waveguide structure 106a, and the distance or spacing between the closed-loop optical waveguide structure 104 and the bus optical waveguide structure 106b, are different distances.

The closed-loop optical waveguide structure 104 is “closed-loop” in that the structure of the closed-loop optical waveguide structure 104 is a continuous waveguide structure that connects to itself with no end points. This is different from other types of modulators and resonators such as Mach-Zender modulators (MZMs) that have end points corresponding to an input and an output. Instead of optical signals being coupled to and from an MZM through propagation of the optical signals through the input and output of the MZM, optical signals are coupled to and from the closed-loop optical waveguide structure 104 through evanescent coupling. Evanescent coupling from the bus optical waveguide structure 106a (or from the bus optical waveguide structure 106b) and the closed-loop optical waveguide structure 104 occurs when the evanescent field of the optical signals propagating through the bus optical waveguide structure 106a (or from the bus optical waveguide structure 106b) extends into the portion of the closed-loop optical waveguide structure 104 that is adjacent to the bus optical waveguide structure 106a (or is adjacent to the bus optical waveguide structure 106b). Similarly, evanescent coupling from the closed-loop optical waveguide structure 104 to the bus optical waveguide structure 106a (or to the bus optical waveguide structure 106b) occurs when the evanescent field of the optical signals propagating through the closed-loop optical waveguide structure 104 extends into a portion of the bus optical waveguide structure 106a (or into a portion of the bus optical waveguide structure 106b).

Optical signal loss occurs in the closed-loop optical waveguide structure 104 as optical signals propagate around the closed-loop optical waveguide structure 104. Optical signal loss in the closed-loop optical waveguide structure 104 (intrinsic loss) may affect the Q factor of the closed-loop optical waveguide structure 104. In some cases, the Q factor may be expressed as the ratio λ_{cen}/λ_{FWHM}, where λ_{cen} is a central wavelength of the optical signal propagating around the closed-loop optical waveguide structure 104 and λ_{FWHM} is a full width at half maximum of the optical signal. The full width at half maximum is a function of the intrinsic loss and corresponds to a bandwidth of the optical signal in which a transmittance (e.g., loss) in the closed-loop optical waveguide structure 104 is less than −3 decibels (dB).

Optical signal also occurs when optical signals are coupled between the closed-loop optical waveguide structure 104 and the bus optical waveguide structure 106a, and/or when optical signals are coupled between the closed-loop optical waveguide structure 104 and the bus optical waveguide structure 106b. Optical signal loss from coupling (external coupling loss) affects a power coupling coefficient (κ value) of the closed-loop optical waveguide structure 104. The power coupling coefficient is an indication of an efficiency of optical signal coupling between the closed-loop optical waveguide structure 104 and the bus optical waveguide structures 106a and/or 106b. In some cases, the power coupling coefficient may be expressed as κ=1−exp(−2πRα), where R is a radius (indicated in FIG. 1A as dimension D1) of the closed-loop optical waveguide structure 104 and a represents the external coupling loss in units of decibels per centimeter (dB/cm).

If the external coupling loss a (which reduces the power coupling coefficient) and intrinsic loss (which affects λ_{FWHM} and thereby reduces the Q factor) are not controlled, the closed-loop optical waveguide structure 104 may not operate efficiently and/or may not effectively filter with high selectivity. For example, when the external coupling loss is greater than the intrinsic loss, the closed-loop optical waveguide structure 104 and the associated bus optical waveguide structures 106a and/or 106b may become under-coupled, resulting in insufficient optical power transfer from the bus optical waveguide structures 106a and/or 106b to the closed-loop optical waveguide structure 104 for modulation and/or filtering. Conversely, when the intrinsic loss is greater than the external coupling loss, the closed-loop optical waveguide structure 104 and the associated bus optical waveguide structures 106a and/or 106b may become over-coupled, resulting in interference in the closed-loop optical waveguide structure 104 (which can cause nonlinear effects and/or other modulation defects) and excessive power consumption in the closed-loop optical waveguide structure 104.

One of the primary contributors to intrinsic loss in a closed-loop optical waveguide structure is bending loss. “Bending loss” refers to optical loss that occurs because of the closed-loop shape of the closed-loop optical waveguide structure. In particular, when an optical signal encounters a bend in the closed-loop optical waveguide structure, optical loss occurs because of absorption of some of the optical signal when the optical signal interacts with the sidewalls of the closed-loop optical waveguide structure in the bend. Bending loss is typically inversely related to the radius of the closed-loop optical waveguide structure. The lesser the radius, the greater the bending loss (because the radius of curvature of the bends in the closed-loop optical waveguide structure is smaller), and the greater the radius, the lesser the bending loss. However, the resonant frequencies of the closed-loop optical waveguide structure are also dependent on the radius. Thus, the closed-loop optical waveguide structure may not be able to be manufactured to have a particular radius to achieve a particular intrinsic loss because a different radius may be needed for modulation and/or filtering of particular wavelengths of the optical signals that are to be processed by the closed-loop optical waveguide structure. As a result, critical coupling may not be able to be achieved for the closed-loop optical waveguide structure.

As illustrated in FIG. 1A, the closed-loop optical waveguide structure 104 includes a polygonal top view shape having a plurality of segments 108 that are coupled at interconnection points 110. Adjacent segments 108 are coupled at adjoining ends of the adjacent segments 108 at an interconnection point 110. Thus, each segment 108 is adjoined to two other segments 108 at opposing ends of the segment 108. In the example in FIG. 1A, a first segment 108 and the interconnection points 110 at opposing ends of the first segment 108 are closest to the bus optical waveguide structure 106a, and a second segment 108 (opposing the first segment 108) and the interconnection points 110 at opposing ends of the second segment 108 are closest to the bus optical waveguide structure 106b. In other implementations, an interconnection point 110 is a portion of the closed-loop optical waveguide structure 104 closest to the bus optical waveguide structure 106a and/or the bus optical waveguide structure 106b.

The segments 108 of the closed-loop optical waveguide structure 104 introduce another type of loss, referred to as segment loss or segment-induced loss, that contributes to the intrinsic loss of the closed-loop optical waveguide structure 104. While the radius of the closed-loop optical waveguide structure 104 may not be able to be selected for tuning the intrinsic loss of the closed-loop optical waveguide structure 104 (e.g., because the radius may be based on achieving particular resonant frequencies for the closed-loop optical waveguide structure 104), the size, shape, and/or quantity of the segments 108 enables a particular segment-induced loss to be achieved for the closed-loop optical waveguide structure 104. Thus, the segment-induced loss enables the intrinsic loss of the closed-loop optical waveguide structure 104 to be tuned without adjusting the radius of the closed-loop optical waveguide structure 104, which enables a particular optical signal loss (intrinsic loss) for the closed-loop optical waveguide structure 104 to be achieved for achieving critical coupling.

FIG. 1A illustrates an example of a polygonal top view shape for the closed-loop optical waveguide structure 104. In the example in FIG. 1A, the closed-loop optical waveguide structure 104 may have an approximately dodecagonal top view shape with twelve (12) interconnected segments 108. In other examples, the top view shape may be hexagonal with six (6) interconnected segments 108, octagonal with eight (8) interconnected segments 108, and/or another polygonal top view shape. Other quantities of segments 108 and other top view shapes are within the scope of the present disclosure. The quantity of segments 108 may be an odd number of segments 108 (e.g., 5 segments, 17 segments) or may be an even number of segments 108 (e.g., 10 segments, 20 segments). In some implementations, the closed-loop optical waveguide structure 104 has a quantity of segments 108 and an arrangement of those segments such that the closed-loop optical waveguide structure 104 is line symmetrical about one or more lines through the center of the closed-loop optical waveguide structure 104. In some implementations, the closed-loop optical waveguide structure 104 has a quantity of segments 108 and an arrangement of those segments such that the closed-loop optical waveguide structure 104 is point symmetrical, meaning that the top view shape of the closed-loop optical waveguide structure 104 has multiple points that are the same distance in opposing directions relative to a central point of the closed-loop optical waveguide structure 104.

The closed-loop optical waveguide structure 104 may be manufactured to have a radius (dimension D1), to have a quantity of segments 108, to have a width (indicated in FIG. 1A as dimension D2) of each segment 108, to have a length (indicated in FIG. 1A as dimension D3) of each segment 108, to have an angle (indicated in FIG. 1A as dimension D4) between adjacent segments 108, and/or to have another attribute such that a particular optical signal loss is achieved for the closed-loop optical waveguide structure 104. In some implementations, the quantity of segments 108, width (dimension D2) of each segment 108, the length (dimension D3) of each segment 108, the angle (dimension D4) between adjacent segments 108, and/or another parameter of the closed-loop optical waveguide structure 104 may be selected to achieve a particular radius (dimension D1) for the closed-loop optical waveguide structure 104. In some implementations, the length (dimension D3) of each segment 108 and/or the angle (dimension D4) between adjacent segments 108 is based on the quantity of the segments 108 included in the closed-loop optical waveguide structure 104.

Moreover, in the example illustrated in FIG. 1A, the widths (dimension D2) of the each of the segments 108 are approximately equal, the lengths (dimension D3) of each of the segments 108 are approximately equal, and the angles (dimension D4) between adjacent segments 108 are approximately equal. In other examples, the widths (dimension D2) of two or more segments 108 of a closed-loop optical waveguide structure 104 are different widths, the lengths (dimension D3) of two or more segments 108 of a closed-loop optical waveguide structure 104 are different lengths, and/or the angles (dimension D4) between two or sets of segments 108 of a closed-loop optical waveguide structure 104 are different angles.

Segment-induced loss may occur at the interconnection points 110 between segments 108 as optical signals transition between the segments 108 of the closed-loop optical waveguide structure 104. In particular, the change in propagation direction that occurs at an interconnection point 110 between adjacent segments 108 results in the segment-induced loss in the optical signals. The segment-induced loss increases as the quantity of the segments 108 decreases. In other words, a lesser quantity of segments 108 results in greater segment-induced loss than a greater quantity of segments 108 for the same radius (dimension D1) because the angle (dimension D4) between adjacent segments 108 less for fewer segments 108 (resulting in sharper changes in direction for optical signals in the closed-loop optical waveguide structure 104) than for a greater quantity of segments 108.

In some implementations, a closed-loop optical waveguide structure 104 with a fixed quantity of segments 108 may have a greater segment-induced loss if the closed-loop optical waveguide structure 104 is manufactured with a greater radius (dimension D1), as the length (dimension D3) of each segment 108 increases as the radius (dimension D1) increases. Thus, the quantity of segments 108 selected for the closed-loop optical waveguide structure 104 may be based on the radius (dimension D1) of the closed-loop optical waveguide structure 104, as well as the intrinsic loss that is to be achieved for the closed-loop optical waveguide structure 104.

In this way, manufacturing the closed-loop optical waveguide structure 104 to have an optical signal loss (e.g., intrinsic loss) by controlling parameters of the closed-loop optical waveguide structure 104 (e.g., the radius (dimension D1), the quantity of segments 108, the width (dimension D2) of the segments 108, the length (dimension D3) of segments 108, and/or the angle (dimension D4) between segments 108, among others) enables the closed-loop optical waveguide structure 104 to achieve critical coupling (or to achieve near-critical coupling). When the closed-loop optical waveguide structure 104 is at or near the critical coupling condition, an extinction ratio (measured in dB) of the closed-loop optical waveguide structure 104 may be greater relative to the over-coupling condition or the under-coupling condition. The extinction ratio of the closed-loop optical waveguide structure 104 represents a difference between the transmittance (in dB) at λ_{cen}, the central wavelength of the optical signal, and the transmittance (in dB) at a wavelength at half maximum of the optical signal. In some cases, when the closed-loop optical waveguide structure 104 is at or near the critical coupling condition, the extinction ratio may approach infinity.

Accordingly, manufacturing the closed-loop optical waveguide structure 104 to have a particular optical signal loss (e.g., intrinsic loss) enables the Q factor for the closed-loop optical waveguide structure 104 to be balanced with the power coupling coefficient for the closed-loop optical waveguide structure 104, which enables the closed-loop optical waveguide structure 104 to achieve critical or near-critical coupling. At or near critical coupling, efficient operation (e.g., modulation or filtering with minimal modulation defects and reduced power consumption) and optical filtering with high selectivity can be achieved for the closed-loop optical waveguide structure 104 relative to over-coupling or under-coupling.

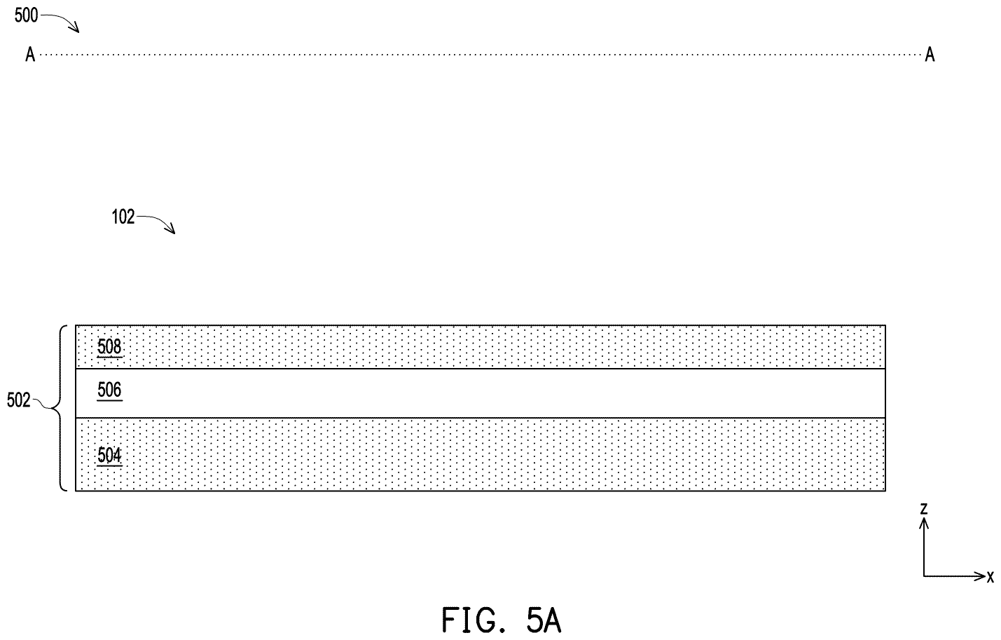

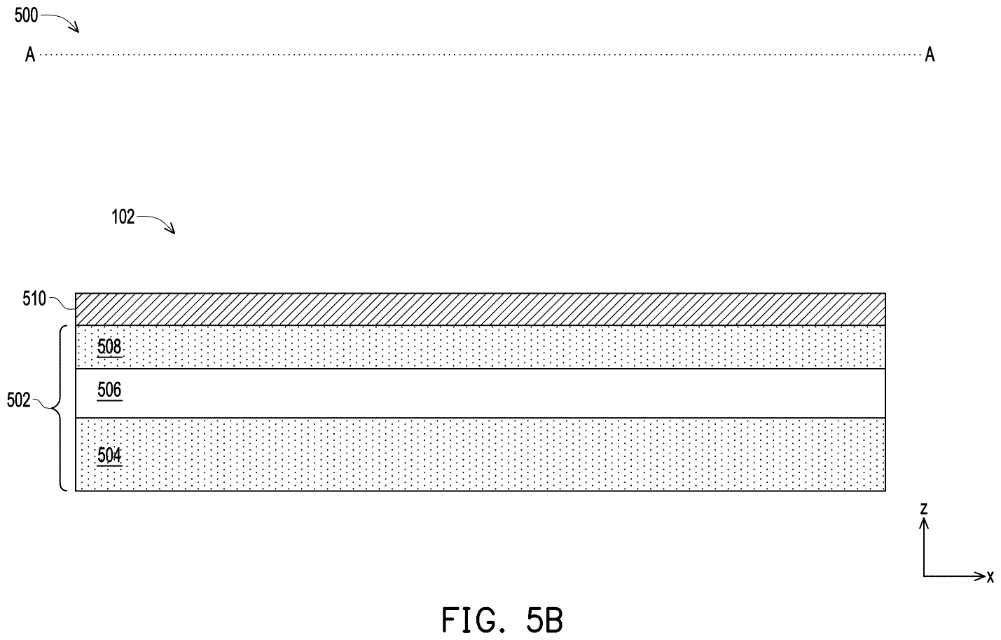

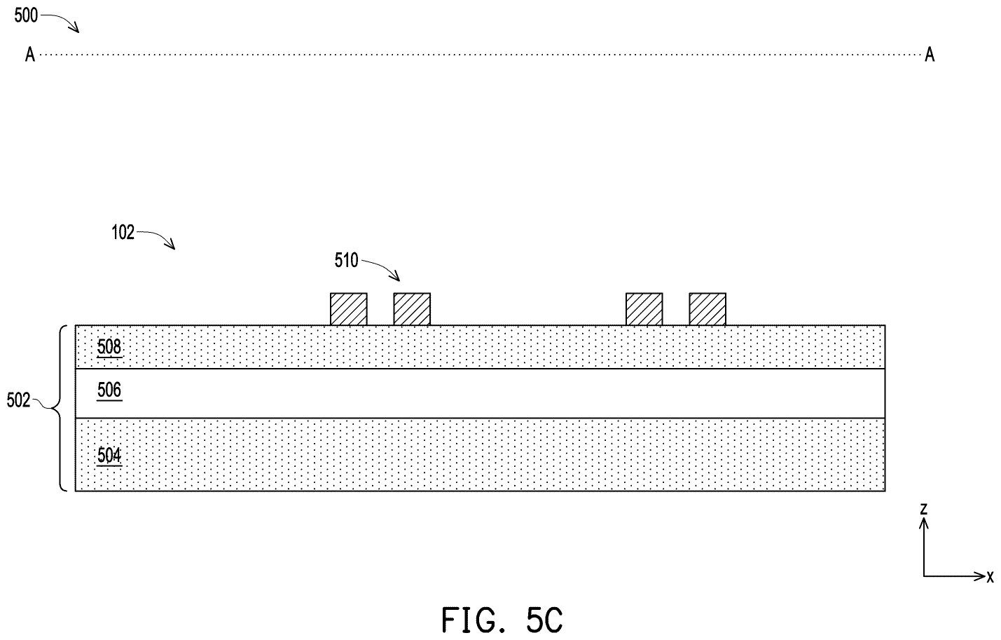

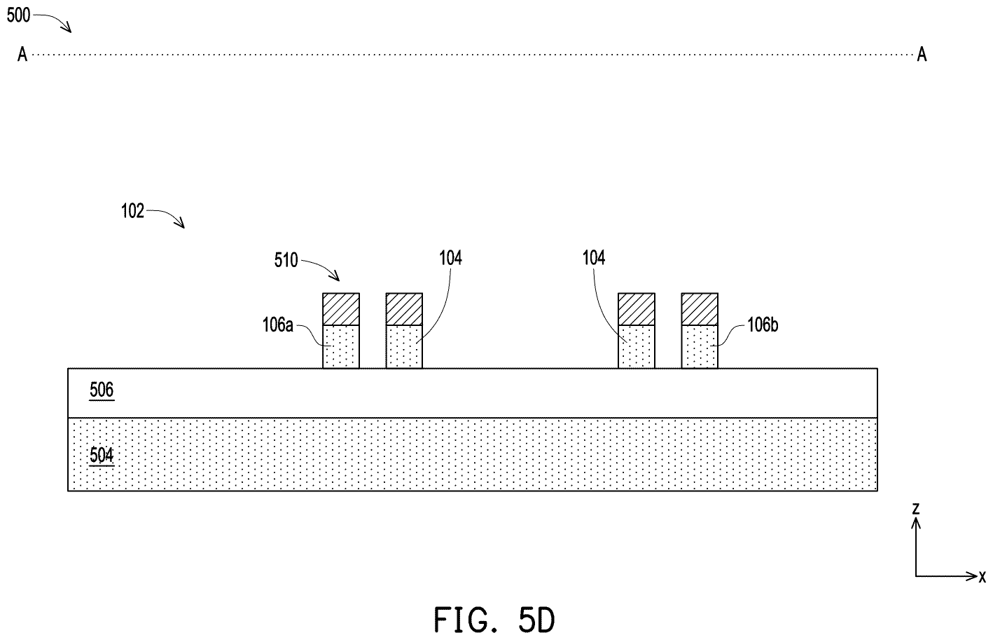

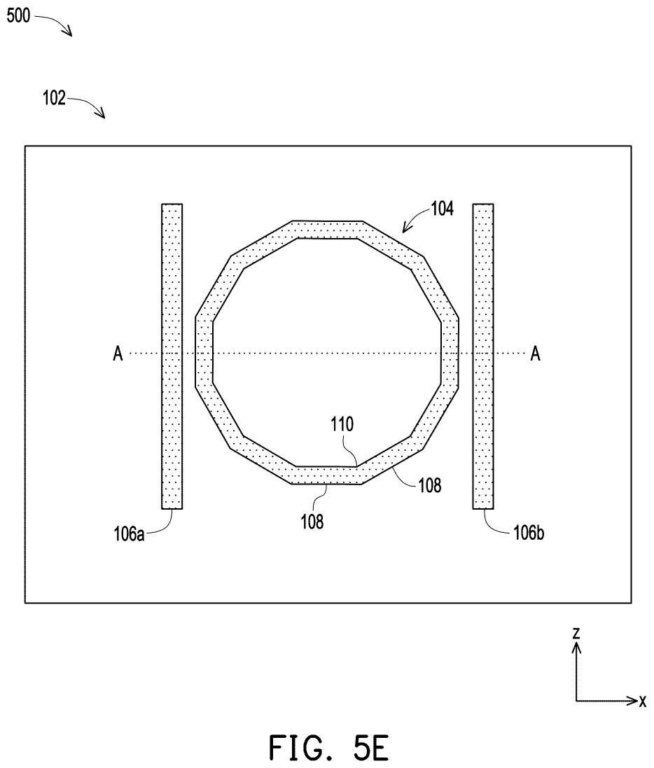

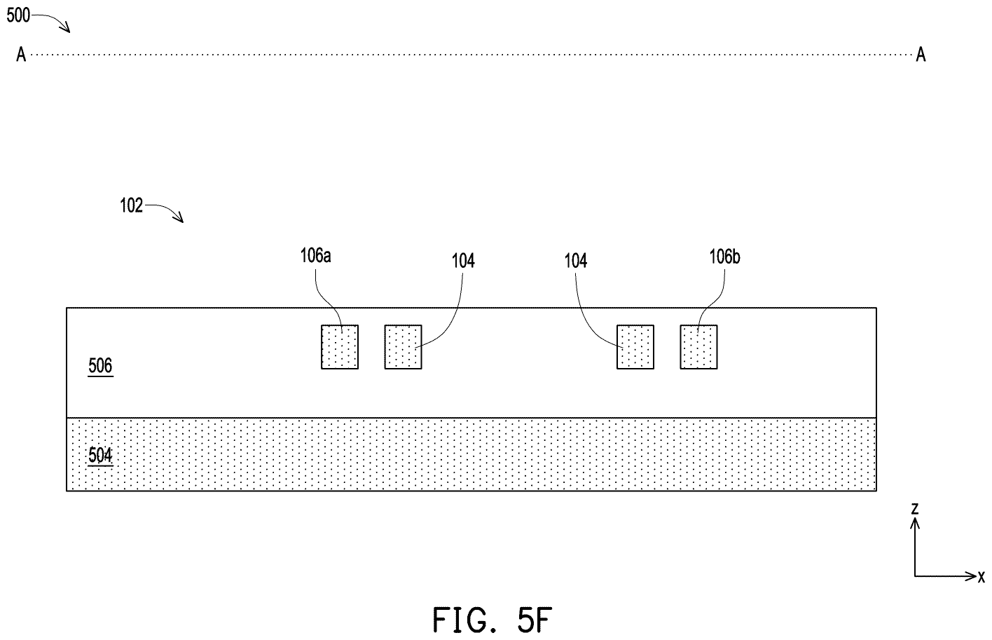

FIG. 1A further illustrates a location of cross-sectional views that are illustrated in other figures included herein. For example, cross-sectional views in FIGS. 5A-5F, 6A-6G, 7A-7D, 8A-8D, 9A-9E, and/or 10A-10D, among other examples, are illustrated along a line A-A in the x-direction across the bus optical waveguide structures 106a and 106b, and the closed-loop optical waveguide structure 104 between the bus optical waveguide structures 106a and 106b.

FIG. 1B illustrates a top view of another example implementation 112 of the semiconductor photonics device 102 in which a plurality of closed-loop optical waveguide structures 104a and 104b are included between the bus optical waveguide structures 106a and 106b. This arrangement enables a cascaded modulator photonic integrated circuit or a cascaded resonator photonic integrated circuit to be implemented in the semiconductor photonics device 102. The example implementation 112 of the semiconductor photonics device 102 in FIG. 1B is an example of a serial cascaded photonic integrated circuit in which the bus optical waveguide structure 106a, the closed-loop optical waveguide structure 104a, the closed-loop optical waveguide structure 104b, and the bus optical waveguide structure 106b are optically coupled in series, which means that the bus optical waveguide structure 106a is directly optically coupled (e.g., through evanescent coupling) with only the closed-loop optical waveguide structure 104a, the bus optical waveguide structure 106b is directly optically coupled (e.g., through evanescent coupling) with only the closed-loop optical waveguide structure 104b, and the closed-loop optical waveguide structure 104a and the closed-loop optical waveguide structure 104b are directly optically coupled together (e.g., through evanescent coupling).

The bus optical waveguide structure 106a is adjacent to a first side (and extends along the first side) of the closed-loop optical waveguide structure 104a. A first side of the closed-loop optical waveguide structure 104b is adjacent to a second side of the closed-loop optical waveguide structure 104a opposing the first side of the closed-loop optical waveguide structure 104a. The bus optical waveguide structure 106b is adjacent to a second side (and extends along the second side) of the closed-loop optical waveguide structure 104b opposing the first side of the closed-loop optical waveguide structure 104b. Thus, the bus optical waveguide structure 106a, the closed-loop optical waveguide structure 104a, the closed-loop optical waveguide structure 104b, and the bus optical waveguide structure 106b are arranged in the x-direction in the semiconductor photonics device 102.

Including a plurality of closed-loop optical waveguide structures 104a and 104b in the semiconductor photonics device 102 enables various functions to be performed using the closed-loop optical waveguide structures 104a and 104b. For example, the closed-loop optical waveguide structures 104a and 104b may be manufactured to have different resonant frequencies, which can be used to generate wavelength division multiplexed (WDM) optical signals in the semiconductor photonics device 102. Additionally and/or alternatively, the closed-loop optical waveguide structures 104a and 104b may be manufactured to have different resonant frequencies to enable filtering of multiple frequencies in the semiconductor photonics device 102.

As further shown in FIG. 1B, the closed-loop optical waveguide structure 104a and the closed-loop optical waveguide structure 104b each have a polygonal top view shape and each include a plurality of segments 108 that are interconnected at interconnection points 110. This enables the optical losses (e.g., the intrinsic losses) in each of the closed-loop optical waveguide structure 104a and the closed-loop optical waveguide structure 104b to be independently tuned.

In some implementations, the closed-loop optical waveguide structure 104a and the closed-loop optical waveguide structure 104b both have the same radius (dimension DI in FIG. 1A), both have the same segment width (dimension D2 in FIG. 1A), both have the same segment length (dimension D3 in FIG. 1A), and/or both have the same segment angle (dimension D4 in FIG. 1A). In some implementations, the closed-loop optical waveguide structure 104a and the closed-loop optical waveguide structure 104b have different radiuses (different dimension D1 values), have different segment widths (different dimension D2 values), have different segment lengths (different dimension D3 values), and/or have different segment angles (different dimension D4 values).

Additionally and/or alternatively, the closed-loop optical waveguide structure 104a and the closed-loop optical waveguide structure 104b may each be manufactured to have different top view orientations. For example, the closed-loop optical waveguide structure 104a may be manufactured to have an octagonal top view shape, and the closed-loop optical waveguide structure 104b may be manufactured to have an octagonal top view shape that is rotated relative to the orientation of the octagonal top view shape of the closed-loop optical waveguide structure 104a.

FIG. 1C illustrates a top view of another example implementation 114 of the semiconductor photonics device 102, which is similar to the example implementation 112 of the semiconductor photonics device 102 illustrated in FIG. 1B. However, in the example implementation 114 of the semiconductor photonics device 102 in FIG. 1C, the semiconductor photonics device 102 includes more than two closed-loop optical waveguide structures 104a-104n, where the closed-loop optical waveguide structures 104a-104n are optically coupled in series. The quantity of the closed-loop optical waveguide structures 104a-104n may be selected to enable filtering of a particular quantity of optical signal frequencies and/or to enable WDM of a particular quantity of optical signal frequencies.

FIG. 1D illustrates a top view of another example implementation 116 of the semiconductor photonics device 102, which is similar to the example implementation 112 of the semiconductor photonics device 102 illustrated in FIG. 1B. However, in the example implementation 116 of the semiconductor photonics device 102 in FIG. 1D, the semiconductor photonics device 102 includes closed-loop optical waveguide structures 104a having a polygonal top view shape in which a plurality of segments 108 are interconnected at interconnection points 110 at opposing ends of the segments 108, and a ring-shaped closed-loop optical waveguide structure 104b adjacent to the closed-loop optical waveguide structure 104a. In other words, the closed-loop optical waveguide structure 104b has a ring-shaped top view shape.

FIG. 1E illustrates a top view of another example implementation 118 of the semiconductor photonics device 102, which is similar to the example implementation 112 of the semiconductor photonics device 102 illustrated in FIG. 1B. However, in the example implementation 118 of the semiconductor photonics device 102 in FIG. 1E, the semiconductor photonics device 102 includes closed-loop optical waveguide structures 104a and 104b that have different polygonal top view shapes. For example, the closed-loop optical waveguide structure 104a may have a dodecagonal top view shape (e.g., may have twelve (12) segments 108) and the closed-loop optical waveguide structure 104b may have a hexagonal top view shape (e.g., may have six (6) segments 108).

As indicated above, FIGS. 1A-1E are provided as examples. Other examples may differ from what is described with regard to FIGS. 1A-1E.

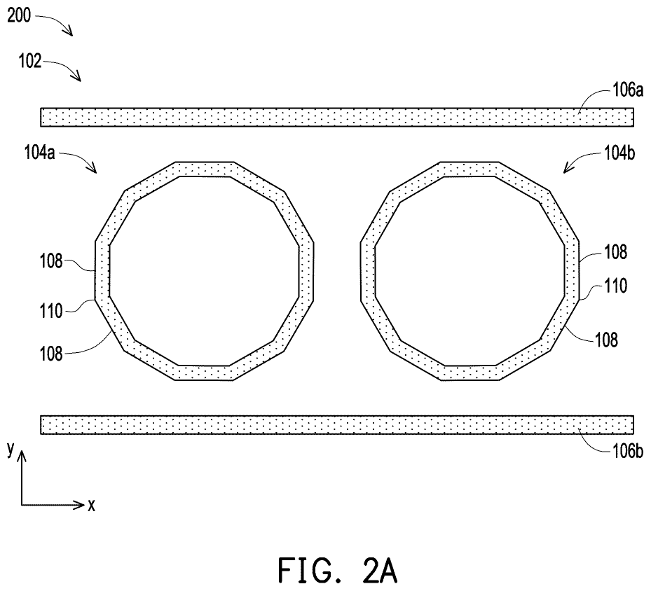

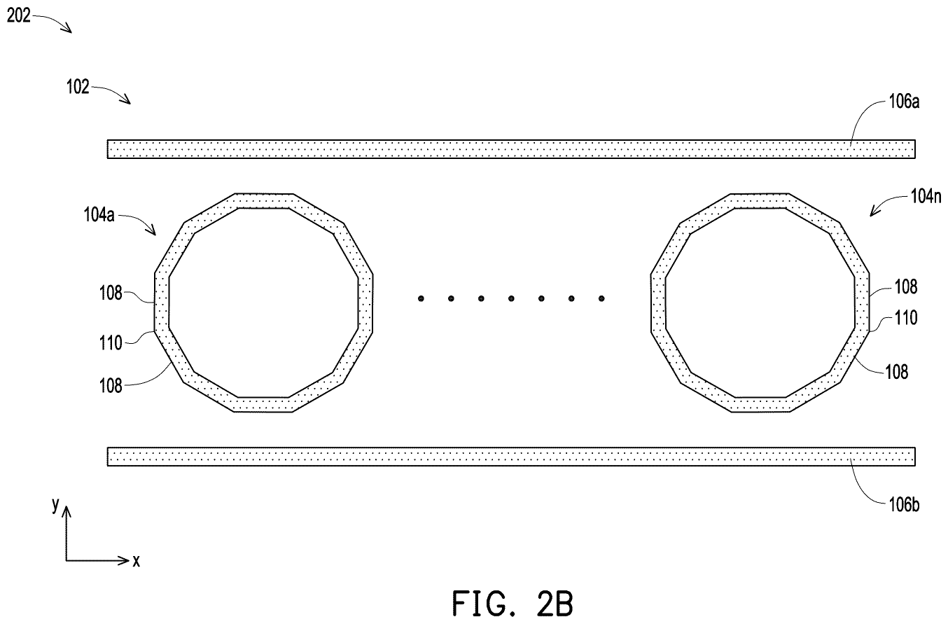

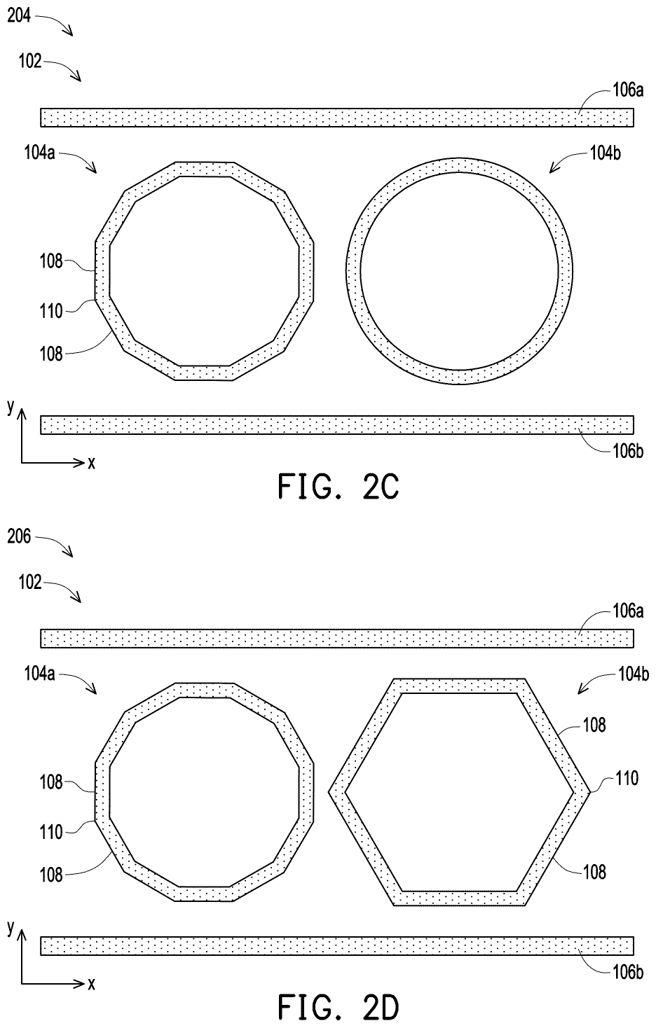

FIGS. 2A-2D are diagrams of example implementations of an example semiconductor photonics device 102 described herein. Each of FIGS. 2A-2D illustrates a top view of an example implementation of a semiconductor photonics device 102.

As shown in an example implementation 200 in FIG. 2A, a semiconductor photonics device 102 includes a plurality of closed-loop optical waveguide structures 104a and 104b between bus optical waveguide structures 106a and 106b. This arrangement enables a cascaded modulator photonic integrated circuit or a cascaded resonator photonic integrated circuit to be implemented in the semiconductor photonics device 102. The example implementation 200 of the semiconductor photonics device 102 in FIG. 2 is an example of a parallel cascaded photonic integrated circuit in which the bus optical waveguide structures 106a and 106b are each directly optically coupled with the closed-loop optical waveguide structures 104a and 104b in parallel, which means that the bus optical waveguide structure 106a is directly optically coupled (e.g., through evanescent coupling) with both the closed-loop optical waveguide structures 104a and 104b at first sides of the closed-loop optical waveguide structures 104a and 104b, and the bus optical waveguide structure 106b is directly optically coupled (e.g., through evanescent coupling) with both the closed-loop optical waveguide structures 104a and 104b at second sides of the closed-loop optical waveguide structures 104a and 104b opposing the first sides. The closed-loop optical waveguide structures 104a and 104b are not directly optically coupled and are instead indirectly coupled through the bus optical waveguide structures 106a and 106b.

In the parallel cascaded photonic integrated circuit, the bus optical waveguide structure 106a continuously extends alongside both the closed-loop optical waveguide structures 104a and 104b at the first sides of the closed-loop optical waveguide structures 104a and 104b. The bus optical waveguide structure 106a continuously extends alongside both the closed-loop optical waveguide structures 104a and 104b at the second sides of the closed-loop optical waveguide structures 104a and 104b. The closed-loop optical waveguide structures 104a and 104b are adjacent to each other in the x-direction in the semiconductor photonics device 102, and are located between the bus optical waveguide structures 106a and 106b in the y-direction in the semiconductor photonics device.

As further shown in FIG. 2A, the closed-loop optical waveguide structure 104a and the closed-loop optical waveguide structure 104b each have a polygonal top view shape and each include a plurality of segments 108 that are interconnected at interconnection points 110. This enables the optical losses (e.g., the intrinsic losses) in each of the closed-loop optical waveguide structure 104a and the closed-loop optical waveguide structure 104b to be independently tuned.

In some implementations, the closed-loop optical waveguide structure 104a and the closed-loop optical waveguide structure 104b both have the same radius (dimension DI in FIG. 1A), both have the same segment width (dimension D2 in FIG. 1A), both have the same segment length (dimension D3 in FIG. 1A), and/or both have the same segment angle (dimension D4 in FIG. 1A). In some implementations, the closed-loop optical waveguide structure 104a and the closed-loop optical waveguide structure 104b have different radiuses (different dimension D1 values), have different segment widths (different dimension D2 values), have different segment lengths (different dimension D3 values), and/or have different segment angles (different dimension D4 values).

Additionally and/or alternatively, the closed-loop optical waveguide structure 104a and the closed-loop optical waveguide structure 104b may each be manufactured to have different top view orientations. For example, the closed-loop optical waveguide structure 104a may be manufactured to have an octagonal top view shape, and the closed-loop optical waveguide structure 104b may be manufactured to have an octagonal top view shape that is rotated relative to the orientation of the octagonal top view shape of the closed-loop optical waveguide structure 104a.

FIG. 2B illustrates a top view of another example implementation 202 of the semiconductor photonics device 102, which is similar to the example implementation 200 of the semiconductor photonics device 102 illustrated in FIG. 2A. However, in the example implementation 202 of the semiconductor photonics device 102 in FIG. 2B, the semiconductor photonics device 102 includes more than two closed-loop optical waveguide structures 104a-104n, where the closed-loop optical waveguide structures 104a-104n are arranged in the x-direction and optically coupled in parallel with the bus optical waveguide structures 106a and 106b. The quantity of the closed-loop optical waveguide structures 104a-104n may be selected to enable filtering of a particular quantity of optical signal frequencies and/or to enable WDM of a particular quantity of optical signal frequencies.

FIG. 2C illustrates a top view of another example implementation 204 of the semiconductor photonics device 102, which is similar to the example implementation 200 of the semiconductor photonics device 102 illustrated in FIG. 2A. However, in the example implementation 204 of the semiconductor photonics device 102 in FIG. 2C, the semiconductor photonics device 102 includes closed-loop optical waveguide structures 104a having a polygonal top view shape in which a plurality of segments 108 are interconnected at interconnection points 110 at opposing ends of the segments 108, and a ring-shaped closed-loop optical waveguide structure 104b adjacent to the closed-loop optical waveguide structure 104a. In other words, the closed-loop optical waveguide structure 104b has a ring-shaped top view shape.

FIG. 2D illustrates a top view of another example implementation 206 of the semiconductor photonics device 102, which is similar to the example implementation 200 of the semiconductor photonics device 102 illustrated in FIG. 2A. However, in the example implementation 206 of the semiconductor photonics device 102 in FIG. 2D, the semiconductor photonics device 102 includes closed-loop optical waveguide structures 104a and 104b that have different polygonal top view shapes. For example, the closed-loop optical waveguide structure 104a may have a dodecagonal top view shape (e.g., may have twelve (12) segments 108) and the closed-loop optical waveguide structure 104b may have a hexagonal top view shape (e.g., may have six (6) segments 108).

As indicated above, FIGS. 2A-2D are provided as examples. Other examples may differ from what is described with regard to FIGS. 2A-2D.

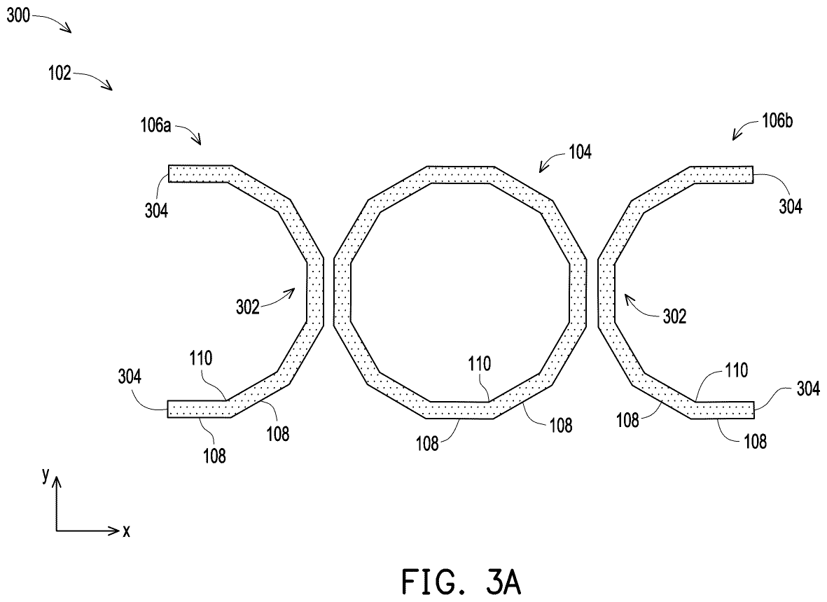

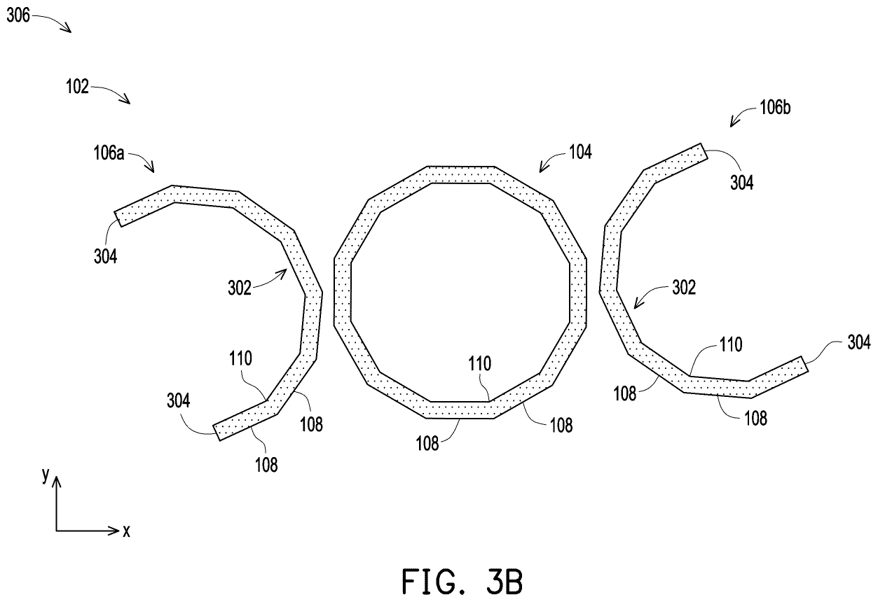

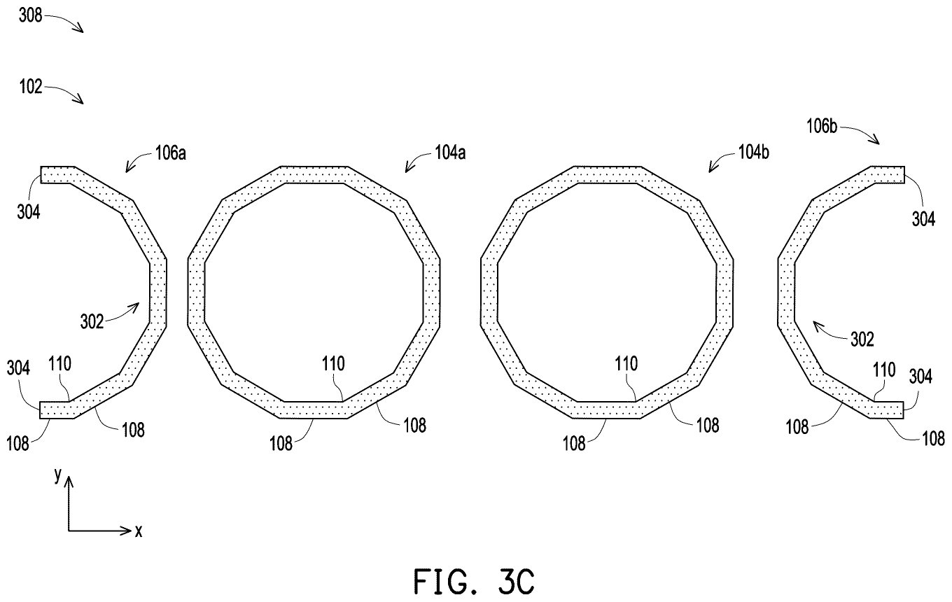

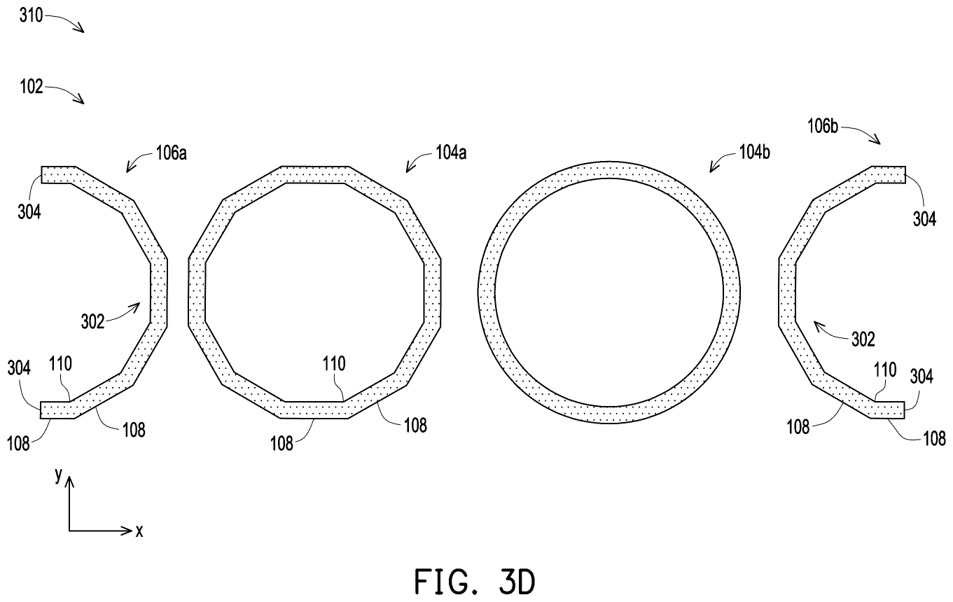

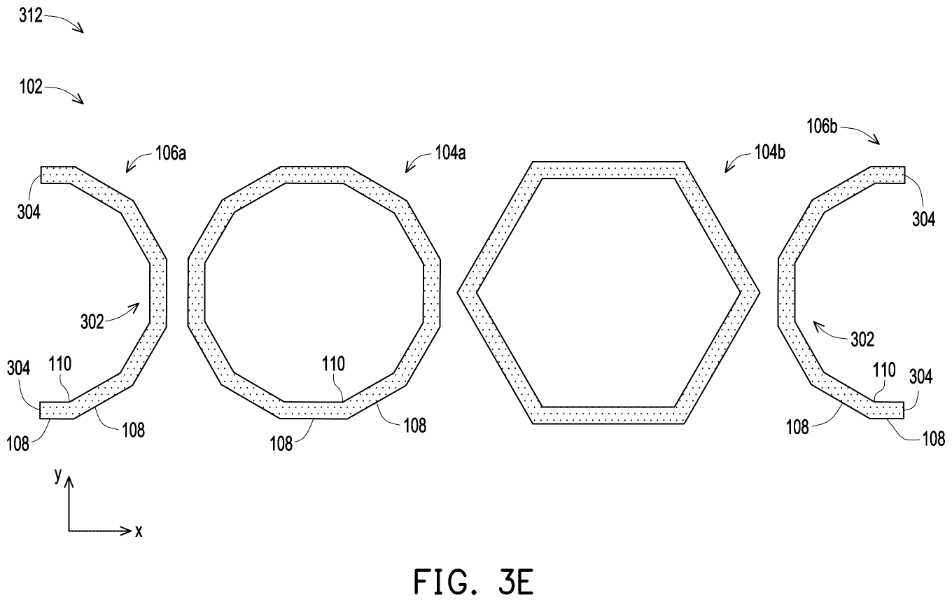

FIGS. 3A-3E are diagrams of example implementations of an example semiconductor photonics device 102 described herein. The example implementations of the semiconductor photonics device 102 illustrated and described in connection with FIGS. 3A-3E are similar to those illustrated and described connection with FIGS. 1A-1E, except that the example implementations of the semiconductor photonics device 102 illustrated and described in connection with FIGS. 3A-3E each include at least one closed-loop optical waveguide structure 104 that has a polygonal top view shape, and a plurality of bus optical waveguide structures 106a and 106b that are each symmetrical to at least a portion of the closed-loop optical waveguide structure 104. This enables the intrinsic loss in the bus optical waveguide structures 106a and 106b to be tuned in a similar manner as the intrinsic loss in the closed-loop optical waveguide structure 104.

FIG. 3A illustrates a top view of an example implementation 300 of the semiconductor photonics device 102. As shown in the top view in FIG. 3A, the example implementation 300 of the semiconductor photonics device 102 is similar to the example implementation 100 of the semiconductor photonics device 102, except that the bus optical waveguide structures 106a and 106b of the semiconductor photonics device 102 in the example implementation 300 each have a polygonal top view. Thus, the bus optical waveguide structures 106a and 106b also includes a plurality of segments 108 that are adjoined at ends of the segments 108 at interconnection points 110. The quantity of segments 108 of the bus optical waveguide structure 106a may be an odd number of segments 108 (e.g., 5 segments, 17 segments) or may be an even number of segments 108 (e.g., 10 segments, 20 segments). Similarly, the quantity of segments 108 of the bus optical waveguide structure 106b may be an odd number of segments 108 (e.g., 5 segments, 17 segments) or may be an even number of segments 108 (e.g., 10 segments, 20 segments). In some implementations, the bus optical waveguide structures 106a and 106b each have the same quantity of segments 108. In some implementations, the bus optical waveguide structures 106a and 106b have different quantities of segments 108.

The top view shapes of each of the bus optical waveguide structures 106a and 106b may be symmetrical to a portion of the top view shape of the closed-loop optical waveguide structure 104. For example, the closed-loop optical waveguide structure 104 may have an approximately dodecagonal top view shape, and the bus optical waveguide structures 106a and 106b may each have a half-dodecagonal top view shape. In some implementations, the bus optical waveguide structures 106a and/or 106b has a quantity of segments 108 and an arrangement of those segments such that the bus optical waveguide structures 106a and/or 106b is line symmetrical about one or more lines through the center of the bus optical waveguide structures 106a and/or 106b. In some implementations, the bus optical waveguide structures 106a and/or 106b has a quantity of segments 108 and an arrangement of those segments such that the bus optical waveguide structures 106a and/or 106b is point symmetrical, meaning that the top view shape of the bus optical waveguide structures 106a and/or 106b has multiple points that are the same distance in opposing directions relative to a central point of the bus optical waveguide structures 106a and/or 106b.

The top view shapes of the bus optical waveguide structures 106a and 106b may be mirrored relative to each other (e.g., mirrored in the x-direction and along the y-direction) and mirrored relative to the side of the closed-loop optical waveguide structure 104 to which the bus optical waveguide structures 106a and 106b are adjacent. Thus, a center point 302 of the bus optical waveguide structure 106a is adjacent to a first side of the closed-loop optical waveguide structure 104, and endpoints 304 of the bus optical waveguide structure 106a are facing away from the first side of the closed-loop optical waveguide structure 104. A center point 302 of the bus optical waveguide structure 106b is adjacent to a second side of the closed-loop optical waveguide structure 104 opposing the first side, and endpoints 304 of the bus optical waveguide structure 106b are facing away from the first side of the closed-loop optical waveguide structure 104.

FIG. 3B illustrates a top view of an example implementation 306 of the semiconductor photonics device 102. As shown in the top view in FIG. 3B, the example implementation 306 is similar to the example implementation 300 in FIG. 3A, except that the bus optical waveguide structures 106a and 106b in the example implementation 306 in FIG. 3B are respectively rotated relative to the bus optical waveguide structures 106a and 106b in the example implementation 300 in FIG. 3A. As a result, the center points 302 of the bus optical waveguide structures 106a and 106b are not aligned in the x-direction as in the example implementation 300 in FIG. 3A, and interconnection points 110 between segments 108 of each of the bus optical waveguide structures 106a and 106b are adjacent to the closed-loop optical waveguide structure 104.

FIG. 3C illustrates a top view of another example implementation 308 of the semiconductor photonics device 102 in which a plurality of closed-loop optical waveguide structures 104a and 104b are included between the bus optical waveguide structures 106a and 106b. This arrangement enables a cascaded modulator photonic integrated circuit or a cascaded resonator photonic integrated circuit to be implemented in the semiconductor photonics device 102. As further shown in FIG. 3C, the closed-loop optical waveguide structure 104a and the closed-loop optical waveguide structure 104b each have a polygonal top view shape and each include a plurality of segments 108 that are interconnected at interconnection points 110. This enables the optical losses (e.g., the intrinsic losses) in each of the closed-loop optical waveguide structure 104a and the closed-loop optical waveguide structure 104b to be independently tuned.

FIG. 3D illustrates a top view of another example implementation 310 of the semiconductor photonics device 102, which is similar to the example implementation 308 of the semiconductor photonics device 102 illustrated in FIG. 3C. However, in the example implementation 310 of the semiconductor photonics device 102 in FIG. 3D, the semiconductor photonics device 102 includes closed-loop optical waveguide structures 104a having a polygonal top view shape in which a plurality of segments 108 are interconnected at interconnection points 110 at opposing ends of the segments 108, and a ring-shaped closed-loop optical waveguide structure 104b adjacent to the closed-loop optical waveguide structure 104a.

FIG. 3E illustrates a top view of another example implementation 312 of the semiconductor photonics device 102, which is similar to the example implementation 308 of the semiconductor photonics device 102 illustrated in FIG. 3C. However, in the example implementation 312 of the semiconductor photonics device 102 in FIG. 3E, the semiconductor photonics device 102 includes closed-loop optical waveguide structures 104a and 104b that have different polygonal top view shapes. For example, the closed-loop optical waveguide structure 104a may have a dodecagonal top view shape (e.g., may have twelve (12) segments 108) and the closed-loop optical waveguide structure 104b may have a hexagonal top view shape (e.g., may have six (6) segments 108).

As indicated above, FIGS. 3A-3E are provided as examples. Other examples may differ from what is described with regard to FIGS. 3A-3E.

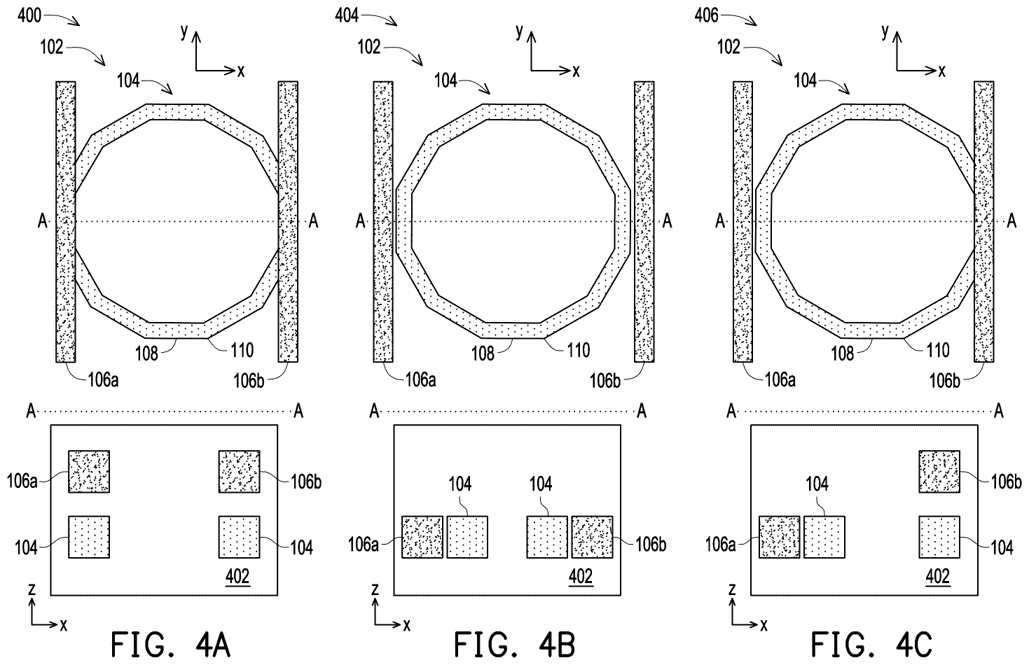

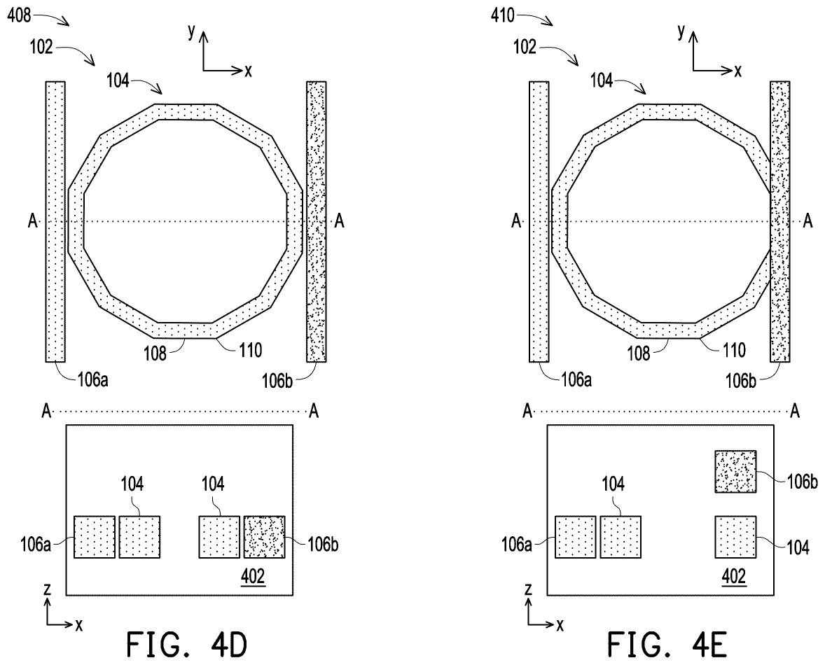

FIGS. 4A-4E are diagrams of example implementations of an example semiconductor photonics device 102 described herein. The example implementations of the semiconductor photonics device 102 illustrated and described in connection with FIGS. 4A-4E are similar to those illustrated and described connection with FIGS. 1A-1E, except that the example implementations of the semiconductor photonics device 102 illustrated and described in connection with FIGS. 4A-4E each include at least one closed-loop optical waveguide structure 104 having a polygonal top view shape, and a plurality of bus optical waveguide structures 106a and 106b, where at least one of the bus optical waveguide structures 106a or 106b includes different material compositions than the material composition of the closed-loop optical waveguide structure 104. This provides increased manufacturing flexibility for manufacturing the closed-loop optical waveguide structure 104 and the bus optical waveguide structures 106 and 106b alternative to, or in addition to, the intrinsic loss tuning through the inclusion of segments 108 in the closed-loop optical waveguide structure 104. Moreover, the closed-loop optical waveguide structure 104 and the bus optical waveguide structures 106a and 106b may be vertically arranged in the z-direction in the semiconductor photonics device 102 (which reduces the lateral footprint in the semiconductor photonics device 102) and/or horizontally arranged in the x-direction in the semiconductor photonics device 102 (which reduces the vertical height of the semiconductor photonics device 102).

FIG. 4A illustrates a top view and an associated cross-section view along the line A-A for an example implementation 400 of the semiconductor photonics device 102. As shown in the top view in FIG. 4A, a closed-loop optical waveguide structure 104 of the semiconductor photonics device 102 has a polygonal top view shape that includes a plurality of segments 108 that are connected at interconnection points 110 at opposing ends of the segments 108. A bus optical waveguide structure 106a may be located over a first portion of the closed-loop optical waveguide structure 104 at a first side of the closed-loop optical waveguide structure 104 such that the first portion of the closed-loop optical waveguide structure 104 and the bus optical waveguide structure 106a are aligned in the x-direction in the semiconductor photonics device 102. A bus optical waveguide structure 106b may be located over a second portion of the closed-loop optical waveguide structure 104 at a second side of the closed-loop optical waveguide structure 104 opposing the first side. Accordingly, the second portion of the closed-loop optical waveguide structure 104 and the bus optical waveguide structure 106b are aligned in the x-direction in the semiconductor photonics device 102.

As shown in the cross-section view in FIG. 4A, the first portion of the closed-loop optical waveguide structure 104 and the bus optical waveguide structure 106a may be vertically arranged in the z-direction in the semiconductor photonics device 102. Similarly, the second portion of the closed-loop optical waveguide structure 104 and the bus optical waveguide structure 106b may be vertically arranged in the z-direction in the semiconductor photonics device 102. The closed-loop optical waveguide structure 104 and the bus optical waveguide structures 106a and 106b may be included in a dielectric layer 402 in the semiconductor photonics device 102. The dielectric layer 402 may include one or more dielectric materials, such as a silicon oxide (SiOₓ), a silicon nitride (SiₓN_{y}), a silicon oxynitride (SiON), tetraethyl orthosilicate oxide, phosphosilicate glass (PSG), borophosphosilicate glass (BPSG), fluorinated silica glass (FSG), carbon doped silicon oxide, and/or another dielectric material.

The closed-loop optical waveguide structure 104 may include different materials or different material compositions than the bus optical waveguide structures 106a and 106b. For example, the closed-loop optical waveguide structure 104 may include one or more semiconductor materials and the bus optical waveguide structures 106a and 106b may each include one or more dielectric materials. As another example, the closed-loop optical waveguide structure 104 may include one or more dielectric materials and the bus optical waveguide structures 106a and 106b may each include one or more semiconductor materials. Examples of such semiconductor materials include silicon (Si), germanium (Ge), silicon germanium (SiGe), silicon doped with one or more types of dopants (e.g., p-type dopants, n-type dopants), germanium doped with one or more times of dopants, and/or another semiconductor material. Examples of such dielectric materials include a silicon oxide (SiOₓ), a silicon nitride (SiₓN_{y}), a silicon oxide doped with one or more types of dopants, a silicon nitride doped with one or more types of dopants, and/or another dielectric material.

In some implementations, the z-direction distance between the bus optical waveguide structure 106a and the first portion of the closed-loop optical waveguide structure 104, and the z-direction distance between the bus optical waveguide structure 106b and the second portion of the closed-loop optical waveguide structure 104, are approximately a same distance. In some implementations, the z-direction distance between the bus optical waveguide structure 106a and the first portion of the closed-loop optical waveguide structure 104, and the z-direction distance between the bus optical waveguide structure 106b and the second portion of the closed-loop optical waveguide structure 104, are different distances.

In some implementations, the thickness of the bus optical waveguide structure 106a and the thickness of the bus optical waveguide structure 106b are approximately a same thickness. In some implementations, the thickness of the bus optical waveguide structure 106a and the thickness of the bus optical waveguide structure 106b are different thicknesses. In some implementations, the width of the bus optical waveguide structure 106a and the width of the bus optical waveguide structure 106b are approximately a same width. In some implementations, the width of the bus optical waveguide structure 106a and the width of the bus optical waveguide structure 106b are different widths.

In some implementations, the thickness of the bus optical waveguide structure 106a and the thickness of the closed-loop waveguide structure 104 are approximately a same thickness. In some implementations, the thickness of the bus optical waveguide structure 106a and the thickness of the closed-loop waveguide structure 104 are different thicknesses. In some implementations, the width of the bus optical waveguide structure 106a and the width of the closed-loop waveguide structure 104 are approximately a same width. In some implementations, the width of the bus optical waveguide structure 106a and the width of the closed-loop waveguide structure 104 are different widths.

In some implementations, the thickness of the bus optical waveguide structure 106b and the thickness of the closed-loop waveguide structure 104 are approximately a same thickness. In some implementations, the thickness of the bus optical waveguide structure 106b and the thickness of the closed-loop waveguide structure 104 are different thicknesses. In some implementations, the width of the bus optical waveguide structure 106b and the width of the closed-loop waveguide structure 104 are approximately a same width. In some implementations, the width of the bus optical waveguide structure 106b and the width of the closed-loop waveguide structure 104 are different widths.

FIG. 4B illustrates a top view and an associated cross-section view along the line A-A for an example implementation 404 of the semiconductor photonics device 102. As shown in FIG. 4B, the example implementation 404 of the semiconductor photonics device 102 illustrated in FIG. 4B is similar to the example implementation 400 of the semiconductor photonics device 102 illustrated in FIG. 4A. However, in the example implementation 404 of the semiconductor photonics device 102 illustrated in FIG. 4B, the bus optical waveguide structures 106a and 106b are positioned horizontally adjacent to opposing sides of the closed-loop optical waveguide structure 104 in the x-direction. For example, the bus optical waveguide structure 106a is horizontally adjacent to the first side of the closed-loop optical waveguide structure 104 in the x-direction, and the bus optical waveguide structure 106a is horizontally adjacent to the second side of the closed-loop optical waveguide structure 104 in the x-direction opposing the first side.

Similar to the example implementation 400 of the semiconductor photonics device 102 illustrated in FIG. 4A, the closed-loop optical waveguide structure 104 may include different materials or different material compositions than the bus optical waveguide structures 106a and 106b in the example implementation 404 of the semiconductor photonics device 102 illustrated in FIG. 4B. For example, the closed-loop optical waveguide structure 104 may include one or more semiconductor materials and the bus optical waveguide structures 106a and 106b may each include one or more dielectric materials. As another example, the closed-loop optical waveguide structure 104 may include one or more dielectric materials and the bus optical waveguide structures 106a and 106b may each include one or more semiconductor materials. Examples of such semiconductor materials include silicon (Si), germanium (Ge), silicon germanium (SiGe), silicon doped with one or more types of dopants (e.g., p-type dopants, n-type dopants), germanium doped with one or more times of dopants, and/or another semiconductor material. Examples of such dielectric materials include a silicon oxide (SiOₓ), a silicon nitride (SiₓN_{y}), a silicon oxide doped with one or more types of dopants, a silicon nitride doped with one or more types of dopants, and/or another dielectric material.

In some implementations, the x-direction distance between the bus optical waveguide structure 106a and the first portion of the closed-loop optical waveguide structure 104, and the x-direction distance between the bus optical waveguide structure 106b and the second portion of the closed-loop optical waveguide structure 104, are approximately a same distance. In some implementations, the x-direction distance between the bus optical waveguide structure 106a and the first portion of the closed-loop optical waveguide structure 104, and the x-direction distance between the bus optical waveguide structure 106b and the second portion of the closed-loop optical waveguide structure 104, are different distances.

In some implementations, the thickness of the bus optical waveguide structure 106a and the thickness of the bus optical waveguide structure 106b are approximately a same thickness. In some implementations, the thickness of the bus optical waveguide structure 106a and the thickness of the bus optical waveguide structure 106b are different thicknesses. In some implementations, the width of the bus optical waveguide structure 106a and the width of the bus optical waveguide structure 106b are approximately a same width. In some implementations, the width of the bus optical waveguide structure 106a and the width of the bus optical waveguide structure 106b are different widths.

In some implementations, the thickness of the bus optical waveguide structure 106a and the thickness of the closed-loop waveguide structure 104 are approximately a same thickness. In some implementations, the thickness of the bus optical waveguide structure 106a and the thickness of the closed-loop waveguide structure 104 are different thicknesses. In some implementations, the width of the bus optical waveguide structure 106a and the width of the closed-loop waveguide structure 104 are approximately a same width. In some implementations, the width of the bus optical waveguide structure 106a and the width of the closed-loop waveguide structure 104 are different widths.

In some implementations, the thickness of the bus optical waveguide structure 106b and the thickness of the closed-loop waveguide structure 104 are approximately a same thickness. In some implementations, the thickness of the bus optical waveguide structure 106b and the thickness of the closed-loop waveguide structure 104 are different thicknesses. In some implementations, the width of the bus optical waveguide structure 106b and the width of the closed-loop waveguide structure 104 are approximately a same width. In some implementations, the width of the bus optical waveguide structure 106b and the width of the closed-loop waveguide structure 104 are different widths.

FIG. 4C illustrates a top view and an associated cross-section view along the line A-A for an example implementation 406 of the semiconductor photonics device 102. As shown in FIG. 4C, the example implementation 406 of the semiconductor photonics device 102 illustrated in FIG. 4C is similar to the example implementation 400 of the semiconductor photonics device 102 illustrated in FIG. 4A. However, in the example implementation 406 of the semiconductor photonics device 102 illustrated in FIG. 4C, the bus optical waveguide structure 106b is positioned horizontally adjacent to the second side of the closed-loop optical waveguide structure 104 in the x-direction, whereas the bus optical waveguide structure 106a is positioned vertically adjacent to the first side of the closed-loop optical waveguide structure 104 in the z-direction.

Similar to the example implementation 400 of the semiconductor photonics device 102 illustrated in FIG. 4A, the closed-loop optical waveguide structure 104 may include different materials or different material compositions than the bus optical waveguide structures 106a and 106b in the example implementation 406 of the semiconductor photonics device 102 illustrated in FIG. 4C. For example, the closed-loop optical waveguide structure 104 may include one or more semiconductor materials and the bus optical waveguide structures 106a and 106b may each include one or more dielectric materials. As another example, the closed-loop optical waveguide structure 104 may include one or more dielectric materials and the bus optical waveguide structures 106a and 106b may each include one or more semiconductor materials. Examples of such semiconductor materials include silicon (Si), germanium (Ge), silicon germanium (SiGe), silicon doped with one or more types of dopants (e.g., p-type dopants, n-type dopants), germanium doped with one or more times of dopants, and/or another semiconductor material. Examples of such dielectric materials include a silicon oxide (SiOₓ), a silicon nitride (SiₓN_{y}), a silicon oxide doped with one or more types of dopants, a silicon nitride doped with one or more types of dopants, and/or another dielectric material.

In some implementations, the x-direction distance between the bus optical waveguide structure 106a and the first portion of the closed-loop optical waveguide structure 104, and the z-direction distance between the bus optical waveguide structure 106b and the second portion of the closed-loop optical waveguide structure 104, are approximately a same distance. In some implementations, the x-direction distance between the bus optical waveguide structure 106a and the first portion of the closed-loop optical waveguide structure 104, and the z-direction distance between the bus optical waveguide structure 106b and the second portion of the closed-loop optical waveguide structure 104, are different distances.

In some implementations, the thickness of the bus optical waveguide structure 106a and the thickness of the bus optical waveguide structure 106b are approximately a same thickness. In some implementations, the thickness of the bus optical waveguide structure 106a and the thickness of the bus optical waveguide structure 106b are different thicknesses. In some implementations, the width of the bus optical waveguide structure 106a and the width of the bus optical waveguide structure 106b are approximately a same width. In some implementations, the width of the bus optical waveguide structure 106a and the width of the bus optical waveguide structure 106b are different widths.

In some implementations, the thickness of the bus optical waveguide structure 106a and the thickness of the closed-loop waveguide structure 104 are approximately a same thickness. In some implementations, the thickness of the bus optical waveguide structure 106a and the thickness of the closed-loop waveguide structure 104 are different thicknesses. In some implementations, the width of the bus optical waveguide structure 106a and the width of the closed-loop waveguide structure 104 are approximately a same width. In some implementations, the width of the bus optical waveguide structure 106a and the width of the closed-loop waveguide structure 104 are different widths.

In some implementations, the thickness of the bus optical waveguide structure 106b and the thickness of the closed-loop waveguide structure 104 are approximately a same thickness. In some implementations, the thickness of the bus optical waveguide structure 106b and the thickness of the closed-loop waveguide structure 104 are different thicknesses. In some implementations, the width of the bus optical waveguide structure 106b and the width of the closed-loop waveguide structure 104 are approximately a same width. In some implementations, the width of the bus optical waveguide structure 106b and the width of the closed-loop waveguide structure 104 are different widths.

FIG. 4D illustrates a top view and an associated cross-section view along the line A-A for an example implementation 408 of the semiconductor photonics device 102. As shown in FIG. 4D, the example implementation 408 of the semiconductor photonics device 102 illustrated in FIG. 4D is similar to the example implementation 404 of the semiconductor photonics device 102 illustrated in FIG. 4B. However, in the example implementation 408 of the semiconductor photonics device 102 illustrated in FIG. 4D, the bus optical waveguide structure 106a includes the same material(s) and/or the same material composition as the material(s) and/or the material composition of the closed-loop optical waveguide structure 104. For example, the bus optical waveguide structure 106a and the closed-loop optical waveguide structure 104 may each include a semiconductor material such as silicon (Si) or doped silicon, and the bus optical waveguide structure 106b may include a dielectric material. Thus, the bus optical waveguide structures 106a and 106b include different materials and/or different material compositions.

In some implementations, the x-direction distance between the bus optical waveguide structure 106a and the first portion of the closed-loop optical waveguide structure 104, and the x-direction distance between the bus optical waveguide structure 106b and the second portion of the closed-loop optical waveguide structure 104, are approximately a same distance. In some implementations, the x-direction distance between the bus optical waveguide structure 106a and the first portion of the closed-loop optical waveguide structure 104, and the x-direction distance between the bus optical waveguide structure 106b and the second portion of the closed-loop optical waveguide structure 104, are different distances.

In some implementations, the thickness of the bus optical waveguide structure 106a and the thickness of the bus optical waveguide structure 106b are approximately a same thickness. In some implementations, the thickness of the bus optical waveguide structure 106a and the thickness of the bus optical waveguide structure 106b are different thicknesses. In some implementations, the width of the bus optical waveguide structure 106a and the width of the bus optical waveguide structure 106b are approximately a same width. In some implementations, the width of the bus optical waveguide structure 106a and the width of the bus optical waveguide structure 106b are different widths.

In some implementations, the thickness of the bus optical waveguide structure 106a and the thickness of the closed-loop waveguide structure 104 are approximately a same thickness. In some implementations, the thickness of the bus optical waveguide structure 106a and the thickness of the closed-loop waveguide structure 104 are different thicknesses. In some implementations, the width of the bus optical waveguide structure 106a and the width of the closed-loop waveguide structure 104 are approximately a same width. In some implementations, the width of the bus optical waveguide structure 106a and the width of the closed-loop waveguide structure 104 are different widths.

In some implementations, the thickness of the bus optical waveguide structure 106b and the thickness of the closed-loop waveguide structure 104 are approximately a same thickness. In some implementations, the thickness of the bus optical waveguide structure 106b and the thickness of the closed-loop waveguide structure 104 are different thicknesses. In some implementations, the width of the bus optical waveguide structure 106b and the width of the closed-loop waveguide structure 104 are approximately a same width. In some implementations, the width of the bus optical waveguide structure 106b and the width of the closed-loop waveguide structure 104 are different widths.

FIG. 4E illustrates a top view and an associated cross-section view along the line A-A for an example implementation 410 of the semiconductor photonics device 102. As shown in FIG. 4E, the example implementation 410 of the semiconductor photonics device 102 illustrated in FIG. 4E is similar to the example implementation 406 of the semiconductor photonics device 102 illustrated in FIG. 4C. However, in the example implementation 410 of the semiconductor photonics device 102 illustrated in FIG. 4E, the bus optical waveguide structure 106a includes the same material(s) and/or the same material composition as the material(s) and/or the material composition of the closed-loop optical waveguide structure 104. For example, the bus optical waveguide structure 106a and the closed-loop optical waveguide structure 104 may each include a semiconductor material such as silicon (Si) or doped silicon, and the bus optical waveguide structure 106b may include a dielectric material. Thus, the bus optical waveguide structures 106a and 106b include different materials and/or different material compositions.

In some implementations, the x-direction distance between the bus optical waveguide structure 106a and the first portion of the closed-loop optical waveguide structure 104, and the z-direction distance between the bus optical waveguide structure 106b and the second portion of the closed-loop optical waveguide structure 104, are approximately a same distance. In some implementations, the x-direction distance between the bus optical waveguide structure 106a and the first portion of the closed-loop optical waveguide structure 104, and the z-direction distance between the bus optical waveguide structure 106b and the second portion of the closed-loop optical waveguide structure 104, are different distances.

In some implementations, the thickness of the bus optical waveguide structure 106a and the thickness of the bus optical waveguide structure 106b are approximately a same thickness. In some implementations, the thickness of the bus optical waveguide structure 106a and the thickness of the bus optical waveguide structure 106b are different thicknesses. In some implementations, the width of the bus optical waveguide structure 106a and the width of the bus optical waveguide structure 106b are approximately a same width. In some implementations, the width of the bus optical waveguide structure 106a and the width of the bus optical waveguide structure 106b are different widths.

In some implementations, the thickness of the bus optical waveguide structure 106a and the thickness of the closed-loop waveguide structure 104 are approximately a same thickness. In some implementations, the thickness of the bus optical waveguide structure 106a and the thickness of the closed-loop waveguide structure 104 are different thicknesses. In some implementations, the width of the bus optical waveguide structure 106a and the width of the closed-loop waveguide structure 104 are approximately a same width. In some implementations, the width of the bus optical waveguide structure 106a and the width of the closed-loop waveguide structure 104 are different widths.

In some implementations, the thickness of the bus optical waveguide structure 106b and the thickness of the closed-loop waveguide structure 104 are approximately a same thickness. In some implementations, the thickness of the bus optical waveguide structure 106b and the thickness of the closed-loop waveguide structure 104 are different thicknesses. In some implementations, the width of the bus optical waveguide structure 106b and the width of the closed-loop waveguide structure 104 are approximately a same width. In some implementations, the width of the bus optical waveguide structure 106b and the width of the closed-loop waveguide structure 104 are different widths.

As indicated above, FIGS. 4A-4E are provided as examples. Other examples may differ from what is described with regard to FIGS. 4A-4E.

FIGS. 5A-5F are diagrams of an example implementation 500 of forming the semiconductor photonics device 102 (or a portion thereof) described herein. In some implementations, one or more of the semiconductor processing operations described in connection with the example implementation 500 may be performed using one or more of the semiconductor processing tools, such as a deposition tool, an exposure tool, a developer tool, an etch tool, a planarization tool, an ion implantation tool, and/or a wafer/die transport tool, among other examples. In some implementations, one or more of the semiconductor processing operations described in connection with the example implementation 500 may be performed to form one or more of the example implementations of the semiconductor photonics device 102 illustrated and described in connection with FIGS. 1A-1E, 2A-2D, and/or 3A-3E, among other examples.

Turning to FIG. 5A, a substrate 502 may be provided. The substrate 502 may include a silicon on insulator (SOI) substrate that includes a semiconductor substrate 504 (e.g., a silicon (Si) substrate and/or another type of semiconductor substrate), a dielectric layer 506 (e.g., a buried oxide or bottom oxide (BOX) layer and/or another type of insulator layer) over and/or on the semiconductor substrate 504, and a semiconductor layer 508 (e.g., a silicon (Si) layer and/or another type of semiconductor layer) over and/or on the dielectric layer 506.

Alternatively, the semiconductor substrate 504 may be provided as a semiconductor wafer, and a deposition tool may be used to form the dielectric layer 506 over and/or on the semiconductor substrate 504, and may form the semiconductor layer 508 over and/or on the dielectric layer 506. A deposition tool may be used to form the dielectric layer 506 using a chemical vapor deposition (CVD) technique, a physical vapor deposition (PVD), an atomic layer deposition (ALD) technique, an oxidation technique (e.g., a thermal oxidation technique), and/or another type of deposition technique. A deposition tool may be used to form the first semiconductor layer 508 using a CVD technique, a PVD technique, an epitaxy technique, and/or another type of deposition technique.

As shown in FIGS. 5B-5D, a plurality of bus optical waveguide structures 106a and 106b, and a closed-loop optical waveguide structure 104, may be formed in the semiconductor layer 508. In some implementations, a pattern in a hard mask layer 510 is used to etch the semiconductor layer 508 to form the bus optical waveguide structures 106a and 106b and the closed-loop optical waveguide structure 104. As shown in FIG. 5B, a deposition tool may be used to form the hard mask layer 510 on the semiconductor layer 508 (e.g., using a CVD technique, a PVD technique, and/or another type of deposition technique).

As shown in FIG. 5C, the hard mask layer 510 may be patterned. The hard mask layer 510 may be patterned using a photoresist layer. A deposition tool may be used to form the photoresist layer on the hard mask layer 510 using a spin-coating technique and/or another type of deposition technique. An exposure tool may be used to expose the photoresist layer to a radiation source to form a pattern the photoresist layer. A developer tool may be used to develop and remove portions of the photoresist layer to expose the pattern. The pattern may be transferred to the hard mask layer 510 by etching the hard mask layer 510 based on the pattern in the photoresist layer.

As shown in FIG. 5D, an etch tool may be used to etch the semiconductor layer 508 to form the bus optical waveguide structures 106a and 106b and the closed-loop optical waveguide structure 104 by removing portions of the semiconductor layer 508 based on the pattern in the hard mask layer 510. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a planarization tool is used to remove the remaining portions of the hard mask layer 510 using a chemical mechanical planarization (CMP) technique and/or another type of planarization technique.

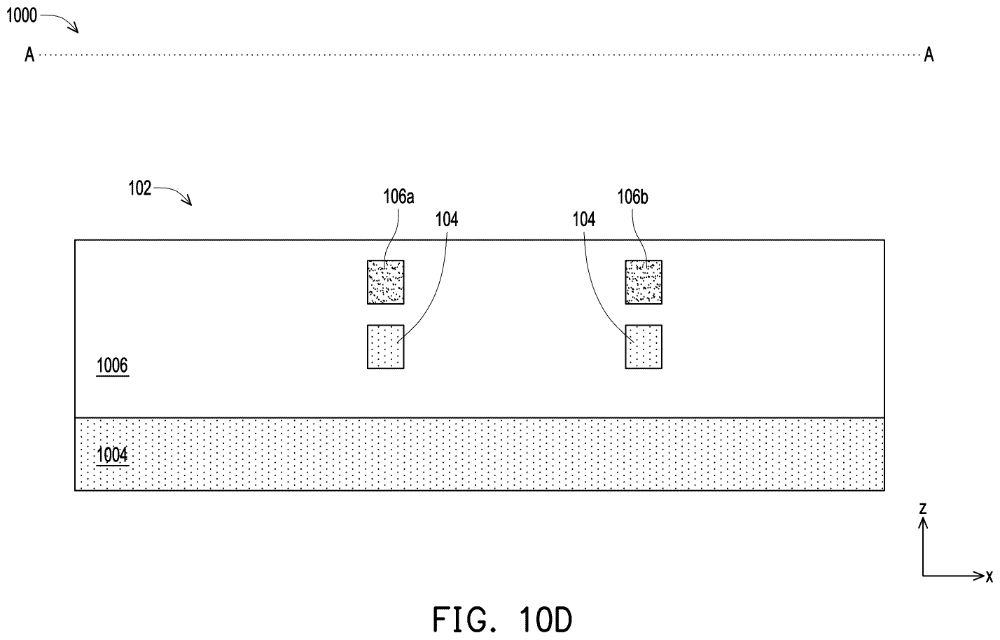

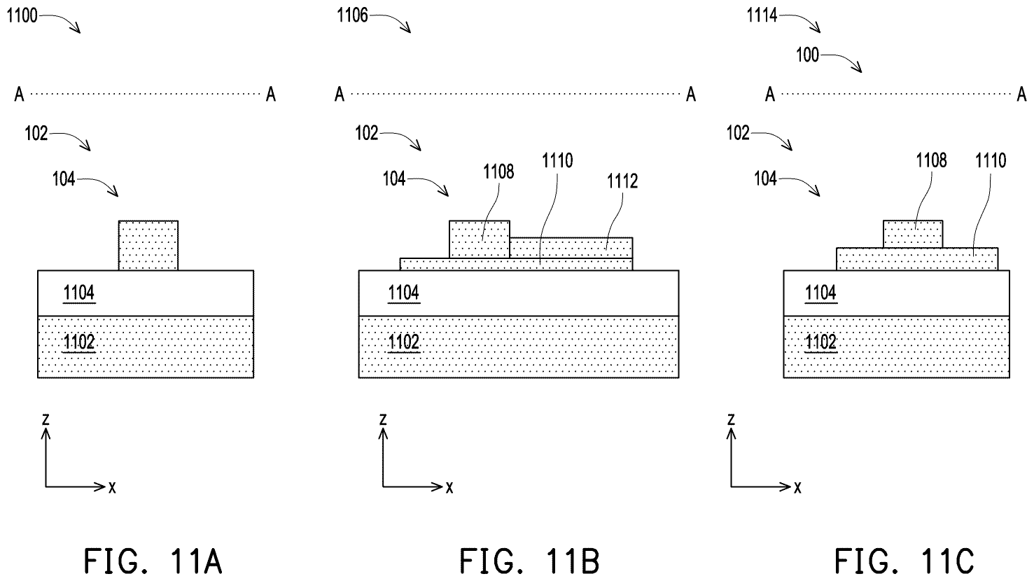

FIG. 5D further illustrates example cross-sectional profiles for the bus optical waveguide structures 106a and 106b and for the closed-loop optical waveguide structure 104. Alternative implementations for the bus optical waveguide structures 106a and 106b and/or for the closed-loop optical waveguide structure 104 are illustrated in connection with FIGS. 11A-11C. As shown, the bus optical waveguide structures 106a and 106b may each include a strip waveguide that includes an approximate rectangular cross-section shape or an approximate square cross-section shape. The closed-loop optical waveguide structure 104 may also have a strip waveguide cross-sectional profile. In some implementations, the closed-loop optical waveguide structure 104 may have terminals or contacts on opposing sides of the strip waveguide to enable voltages to be applied to the closed-loop optical waveguide structure 104 for modifying the refractive index of the closed-loop optical waveguide structure 104 for modulating optical signals.

As shown in a top view of the semiconductor photonics device 102 in FIG. 5E, the closed-loop optical waveguide structure 104 may be formed to have a polygonal top view shape having a plurality of segments 108 that are connected at interconnection points 110 that are located at opposing ends of the segments 108, as illustrated in the example implementations of the closed-loop optical waveguide structure 104 in FIGS. 1A-1E, 2A-2D, and/or 3A-3E, among other examples.

As shown in FIG. 5F, additional material for the dielectric layer 506 may be deposited to encapsulate the bus optical waveguide structures 106a and 106b and the closed-loop optical waveguide structure 104 in the dielectric layer 506. A deposition tool may be used to deposit the additional material for the dielectric layer 506 using a CVD technique, a PVD technique, an oxidation technique (e.g., a thermal oxidation technique), and/or another type of deposition technique. In some implementations, one or more additional semiconductor processing operations may be performed to deposit the additional material of the dielectric layer 706. For example, a deposition tool may be used to perform a shallow trench isolation (STI) liner oxidation operation and/or a high density plasma (HDP) deposition operation to deposit the additional material of the dielectric layer 506. As another example, a planarization tool may be used to perform a CMP operation and/or another type of planarization operation to planarize the dielectric layer 506 after the additional material of the dielectric layer 506 is deposited.

As indicated above, FIGS. 5A-5F are provided as an example. Other examples may differ from what is described with regard to FIGS. 5A-5F.

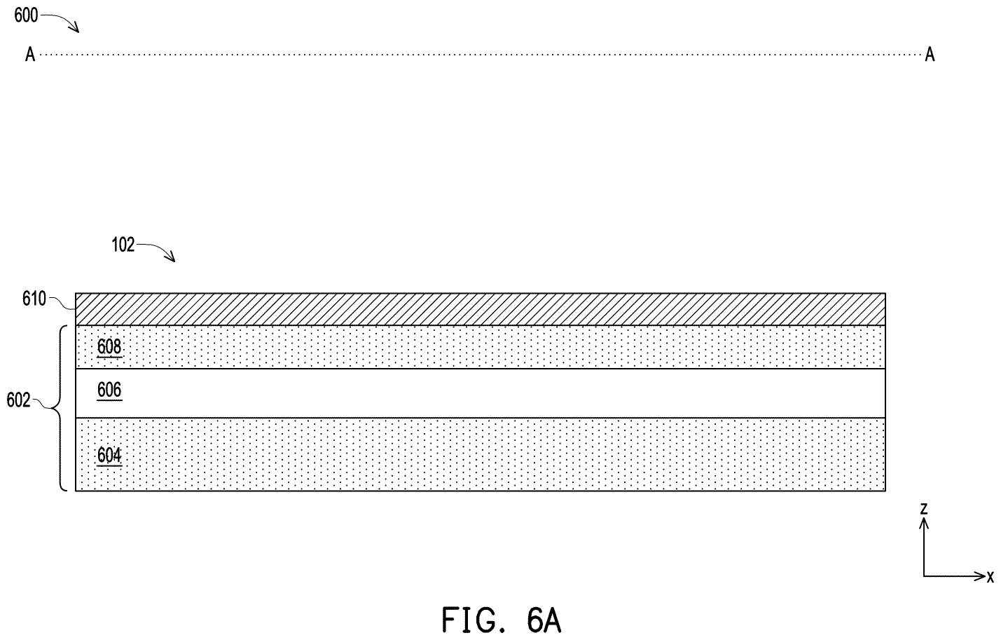

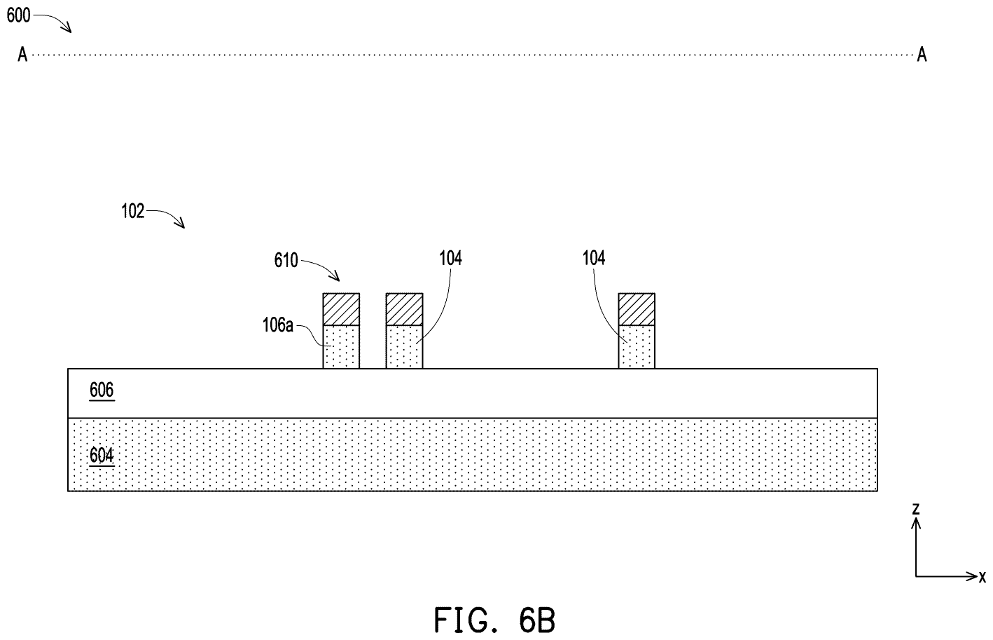

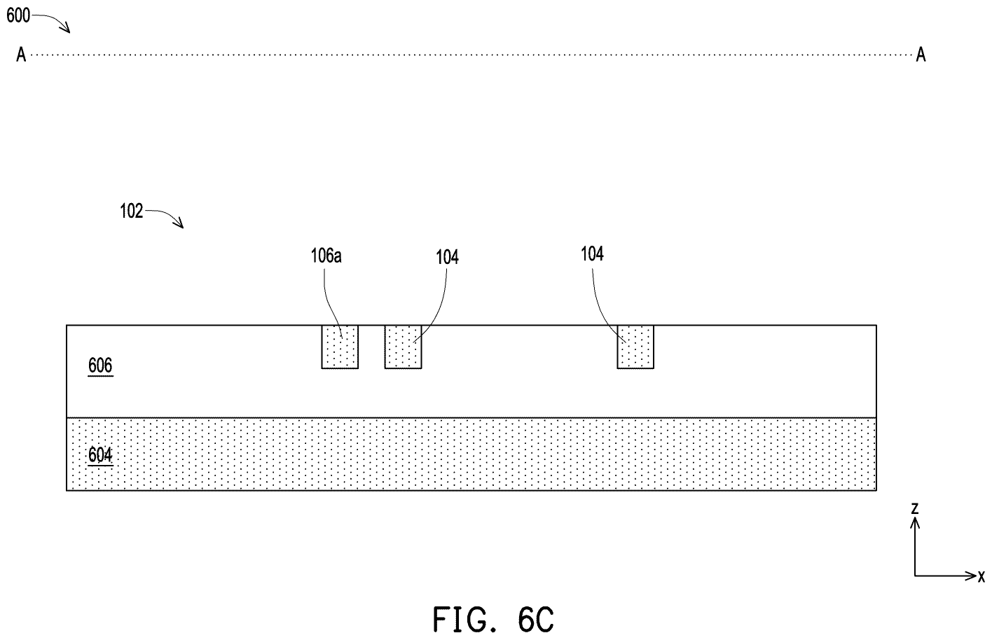

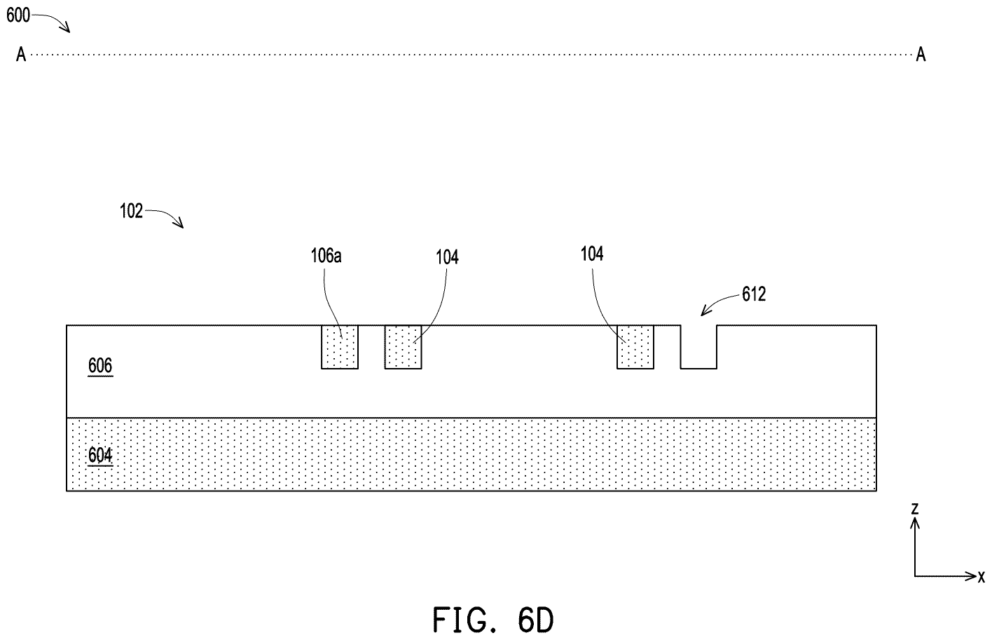

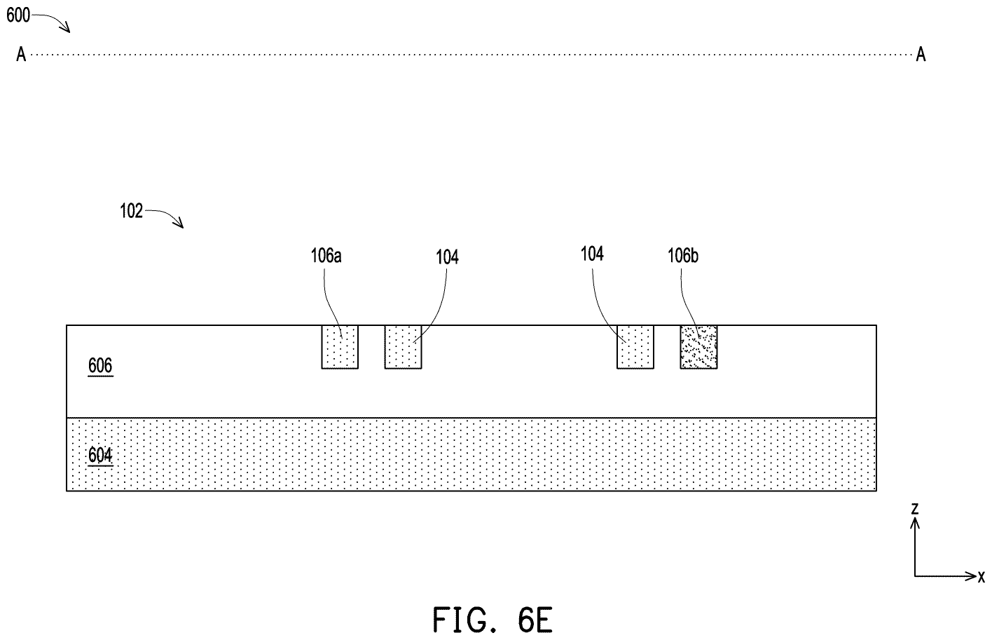

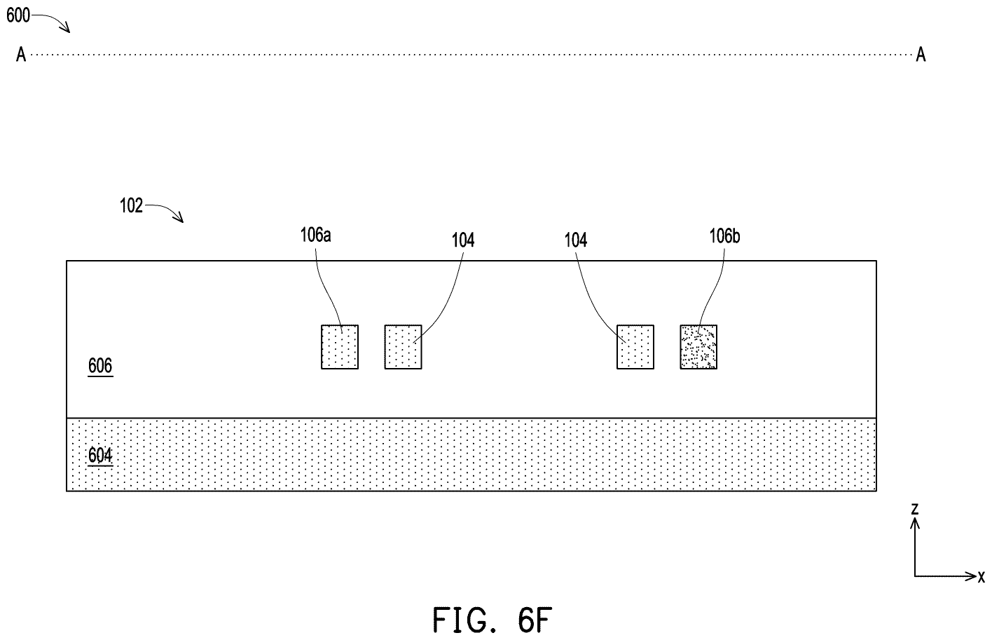

FIGS. 6A-6F are diagrams of an example implementation 600 of forming the semiconductor photonics device 102 (or a portion thereof) described herein. In some implementations, one or more of the semiconductor processing operations described in connection with the example implementation 600 may be performed using one or more of the semiconductor processing tools, such as a deposition tool, an exposure tool, a developer tool, an etch tool, a planarization tool, an ion implantation tool, and/or a wafer/die transport tool, among other examples. In some implementations, one or more of the semiconductor processing operations described in connection with the example implementation 600 may be performed to form one or more of the example implementations of the semiconductor photonics device 102 illustrated and described in connection with FIGS. 1A-1E, 2A-2D, 3A-3E, and/or 4D, among other examples.

Turning to FIG. 6A, a substrate 602 may be provided. The substrate 602 may include a semiconductor substrate 604, a dielectric layer 606, and a semiconductor layer 608, similar to the substrate 502 in the example implementation 500. As further shown in FIG. 6A, a hard mask layer 610 may be formed on the semiconductor layer 608 and patterned similarly to the hard mask layer 510 in the example implementation 500. However, in the example implementation 600, the hard mask layer 610 is patterned for formation of a closed-loop optical waveguide structure 104 and only the bus optical waveguide structure 106a (e.g., not for the bus optical waveguide structure 106b).

As shown in FIG. 6b, an etch tool is used to etch the semiconductor layer 608 to form a closed-loop optical waveguide structure 104 and to form a bus optical waveguide structure 106a adjacent to a first side of the closed-loop optical waveguide structure 104 by removing portions of the semiconductor layer 608 based on the pattern in the hard mask layer 610. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a planarization tool is used to remove the remaining portions of the hard mask layer 610 using a CMP technique and/or another type of planarization technique. The closed-loop optical waveguide structure 104 may be formed to have a polygonal top view shape having a plurality of segments 108 that are connected at interconnection points 110 at opposing ends of the segments 108, as illustrated in the example implementations of the closed-loop optical waveguide structure 104 in FIGS. 1A-1E, 2A-2D, 3A-3E, and/or 4D, among other examples.

As shown in FIG. 6C, additional material for the dielectric layer 606 may be deposited around the closed-loop optical waveguide structure 104 and the bus optical waveguide structure 106a. A deposition tool may be used to deposit the additional material for the dielectric layer 606 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 606 after the additional material of the dielectric layer 606 is deposited.

As shown in FIG. 6D, a recess 612 may be formed in the dielectric layer 606. The recess 612 is formed laterally adjacent to a second side of the closed-loop optical waveguide structure 104 in the x-direction opposing the first side adjacent to which the bus optical waveguide structure 106a was formed. In some implementations, a pattern in a photoresist layer is used to etch the dielectric layer 606 to form the recess 612. In these implementations, a deposition tool may be used to form the photoresist layer on the dielectric layer 606. An exposure tool may be used to expose the photoresist layer to a radiation source to pattern the photoresist layer. A developer tool may be used to develop and remove portions of the photoresist layer to expose the pattern. An etch tool may be used to etch the dielectric layer 606 based on the pattern to form the recess 612 in the dielectric layer 606. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 606 based on a pattern.

As shown in FIG. 6E, dielectric material may be deposited in the recess 612 to form the bus optical waveguide structure 106b in the recess 612. Thus, the bus optical waveguide structure 106b is formed laterally adjacent to the second side of the closed-loop optical waveguide structure 104 in the x-direction opposing the first side adjacent to which the bus optical waveguide structure 106a was formed. A deposition tool may be used to deposit the dielectric material of the bus optical waveguide structure 106b using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the bus optical waveguide structure 106b after the additional material of the dielectric material of the bus optical waveguide structure 106b is deposited.

As shown in FIG. 6F, additional material for the dielectric layer 606 may be deposited to encapsulate the closed-loop optical waveguide structure 104 and the bus optical waveguide structures 106a and 106b in the dielectric layer 606. A deposition tool may be used to deposit the additional material for the dielectric layer 606 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 606 after the additional material of the dielectric layer 606 is deposited.

As indicated above, FIGS. 6A-6F are provided as an example. Other examples may differ from what is described with regard to FIGS. 6A-6F.

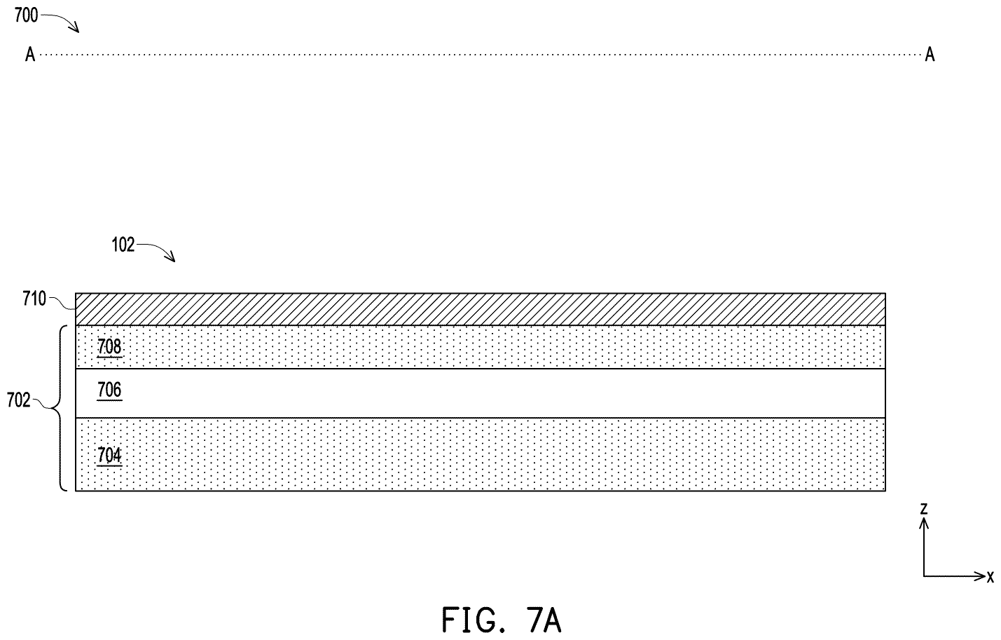

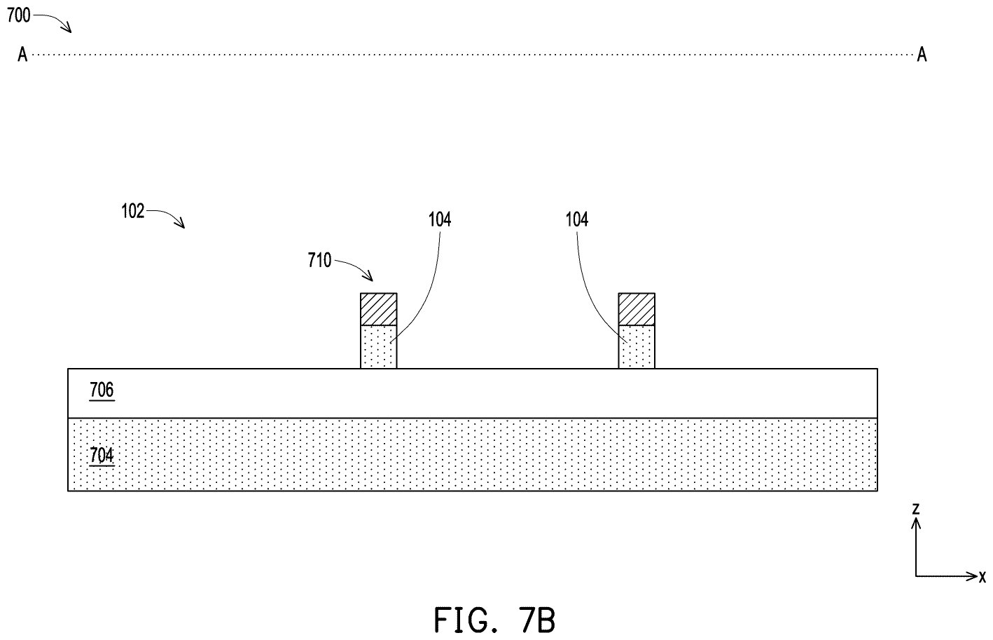

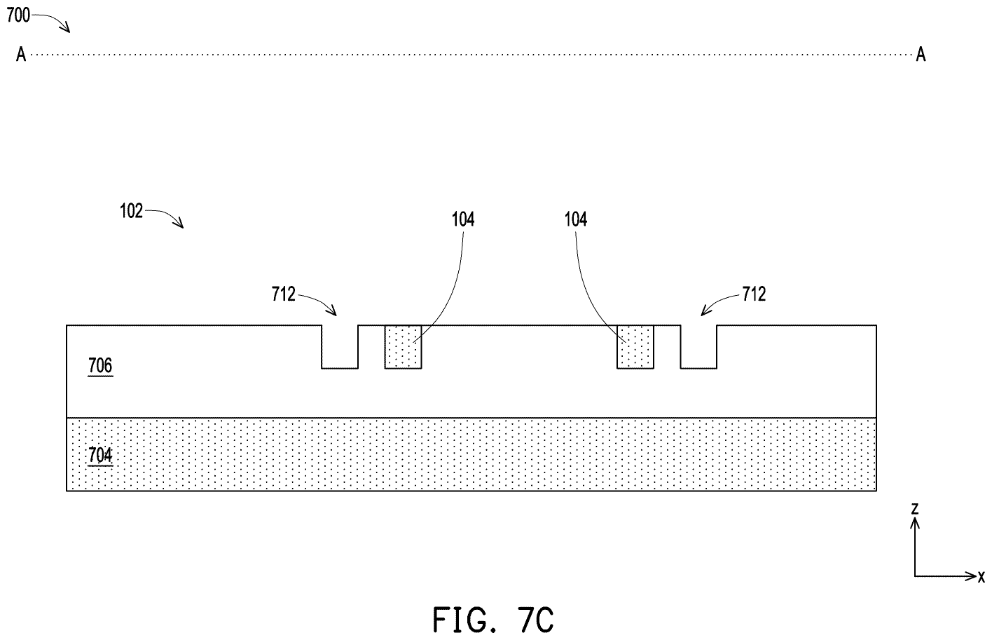

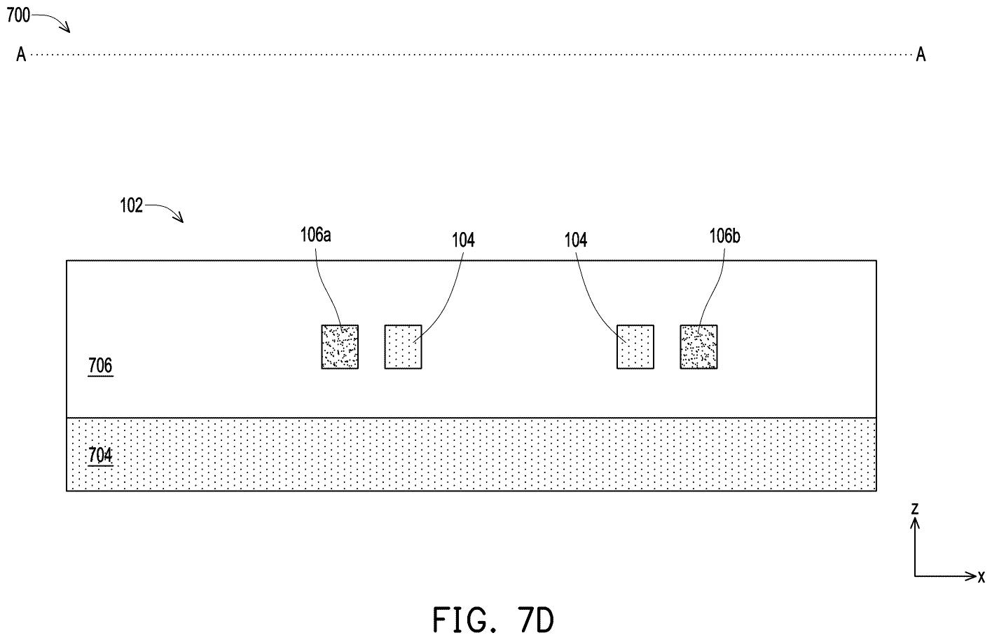

FIGS. 7A-7D are diagrams of an example implementation 700 of forming the semiconductor photonics device 102 (or a portion thereof) described herein. In some implementations, one or more of the semiconductor processing operations described in connection with the example implementation 700 may be performed using one or more of the semiconductor processing tools, such as a deposition tool, an exposure tool, a developer tool, an etch tool, a planarization tool, an ion implantation tool, and/or a wafer/die transport tool, among other examples. In some implementations, one or more of the semiconductor processing operations described in connection with the example implementation 700 may be performed to form one or more of the example implementations of the semiconductor photonics device 102 illustrated and described in connection with FIGS. 1A-1E, 2A-2D, 3A-3E, and/or 4B, among other examples.

Turning to FIG. 7A, a substrate 702 may be provided. The substrate 702 may include a semiconductor substrate 704, a dielectric layer 706, and a semiconductor layer 708, similar to the substrate 502 in the example implementation 500. As further shown in FIG. 7A, a hard mask layer 710 may be formed on the semiconductor layer 708 and patterned similarly to the hard mask layer 510 in the example implementation 500. However, in the example implementation 700, the hard mask layer 710 is patterned for formation only of a closed-loop optical waveguide structure 104 and not for formation of bus optical waveguide structures 106a and 106b.

As shown in FIG. 7B, an etch tool is used to etch the semiconductor layer 708 to form the closed-loop optical waveguide structure 104 by removing portions of the semiconductor layer 708 based on the pattern in the hard mask layer 710. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a planarization tool is used to remove the remaining portions of the hard mask layer 710 using a CMP technique and/or another type of planarization technique. The closed-loop optical waveguide structure 104 may be formed to have a polygonal top view shape having a plurality of segments 108 that are connected at interconnection points 110 at opposing ends of the segments 108, as illustrated in the example implementations of the closed-loop optical waveguide structure 104 in FIGS. 1A-1E, 2A-2D, 3A-3E, and/or 4B, among other examples.

As shown in FIG. 7C, additional material for the dielectric layer 706 may be deposited around the closed-loop optical waveguide structure 104. A deposition tool may be used to deposit the additional material for the dielectric layer 706 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 706 after the additional material of the dielectric layer 706 is deposited.

As further shown in FIG. 7C, a plurality of recesses 712 may be formed in the dielectric layer 706. A first recess 712 is formed laterally adjacent to a first side of the closed-loop optical waveguide structure 104 in the x-direction. A second recess 712 is formed laterally adjacent to a second side of the closed-loop optical waveguide structure 104 in the x-direction opposing the first side adjacent to which the first recess 712 was formed. In some implementations, a pattern in a photoresist layer is used to etch the dielectric layer 706 to form the recesses 712. In these implementations, a deposition tool may be used to form the photoresist layer on the dielectric layer 706. An exposure tool may be used to expose the photoresist layer to a radiation source to pattern the photoresist layer. A developer tool may be used to develop and remove portions of the photoresist layer to expose the pattern. An etch tool may be used to etch the dielectric layer 706 based on the pattern to form the recesses 712 in the dielectric layer 706. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 706 based on a pattern.

In some implementations, the distance between the first recess 712 and the first side of the closed-loop optical waveguide structure 104, and the distance between the second recess 712 and the second side of the closed-loop optical waveguide structure 104, are approximately a same distance. In some implementations, the distance between the first recess 712 and the first side of the closed-loop optical waveguide structure 104, and the distance between the second recess 712 and the second side of the closed-loop optical waveguide structure 104, are different distances.

In some implementations, the depth of the first recess 712 and the depth of the second recess 712 are approximately a same depth. In some implementations, the depth of the first recess 712 and the depth of the second recess 712 are different depths. In some implementations, the width of the first recess 712 and the width of the second recess 712 are approximately a same width. In some implementations, the width of the first recess 712 and the width of the second recess 712 are different widths.

In some implementations, the depth of the first recess 712 and the thickness of the closed-loop waveguide structure 104 are approximately the same. In some implementations, the depth of the first recess 712 and the thickness of the closed-loop waveguide structure 104 are different. In some implementations, the width of the first recess 712 and the width of the closed-loop waveguide structure 104 are approximately a same width. In some implementations, the width of the first recess 712 and the width of the closed-loop waveguide structure 104 are different widths.

In some implementations, the depth of the second recess 712 and the thickness of the closed-loop waveguide structure 104 are approximately the same. In some implementations, the depth of the second recess 712 and the thickness of the closed-loop waveguide structure 104 are different. In some implementations, the width of the second recess 712 and the width of the closed-loop waveguide structure 104 are approximately a same width. In some implementations, the width of the second recess 712 and the width of the closed-loop waveguide structure 104 are different widths.

As shown in FIG. 7D, dielectric material may be deposited in the recesses 712 to form the bus optical waveguide structures 106a and 106b. Dielectric material may be deposited in the first recess 712 to form the bus optical waveguide structure 106a laterally adjacent to the first side of the closed-loop optical waveguide structure 104 in the x-direction. Dielectric material may be deposited in the second recess 712 to form the bus optical waveguide structure 106b laterally adjacent to the second side of the closed-loop optical waveguide structure 104 in the x-direction opposing the first side adjacent. A deposition tool may be used to deposit the dielectric material of the bus optical waveguide structures 106a and 106b using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the bus optical waveguide structures 106a and 106b after the additional material of the dielectric material of the bus optical waveguide structures 106a and 106b are deposited.

As further shown in FIG. 7D, additional material for the dielectric layer 706 may be deposited to encapsulate the closed-loop optical waveguide structure 104 and the bus optical waveguide structures 106a and 106b in the dielectric layer 706. A deposition tool may be used to deposit the additional material for the dielectric layer 706 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 706 after the additional material of the dielectric layer 706 is deposited.

As indicated above, FIGS. 7A-7D are provided as an example. Other examples may differ from what is described with regard to FIGS. 7A-7D.

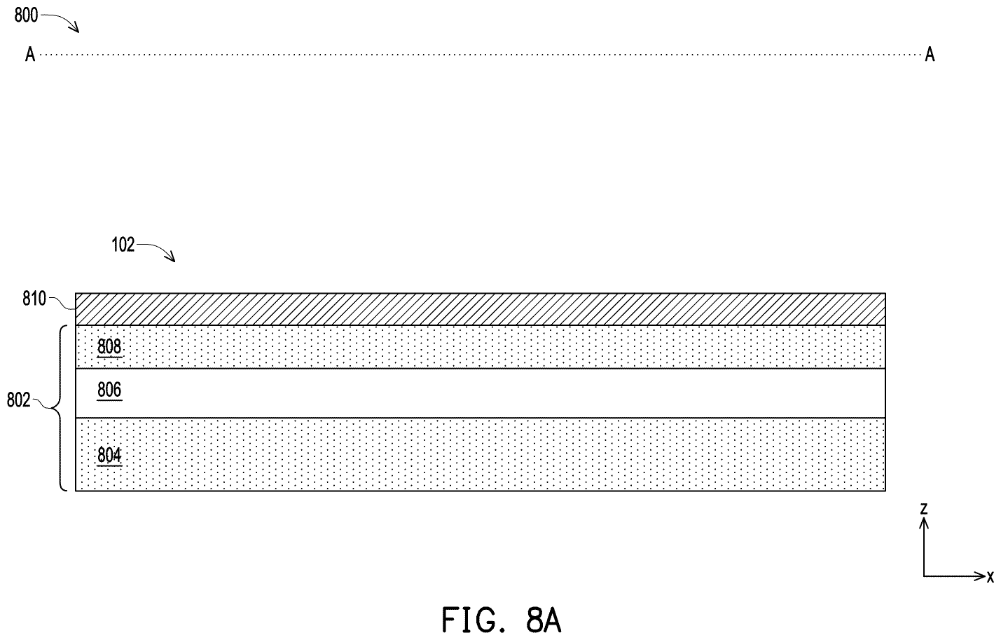

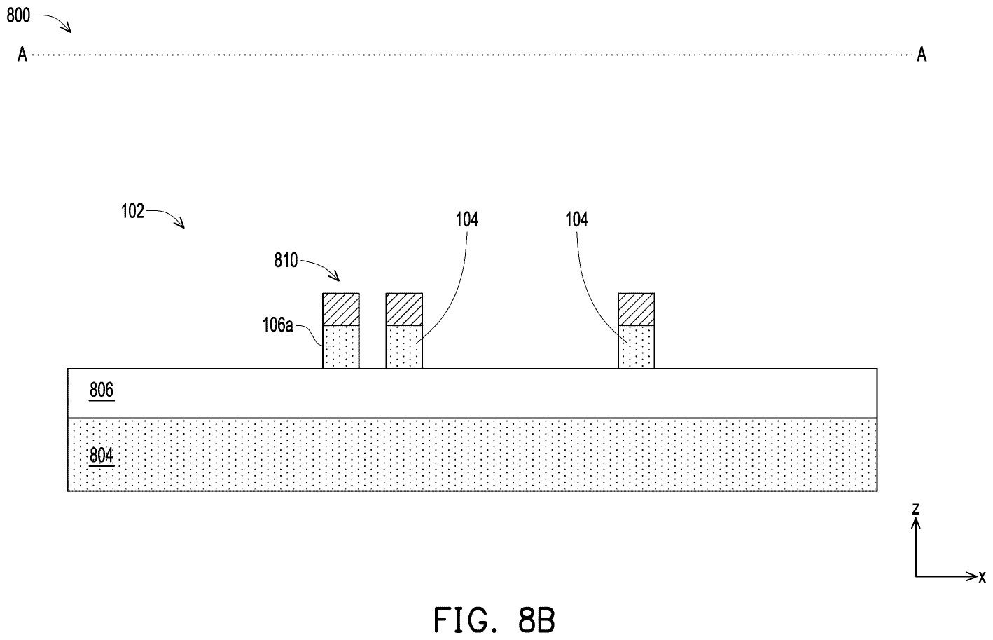

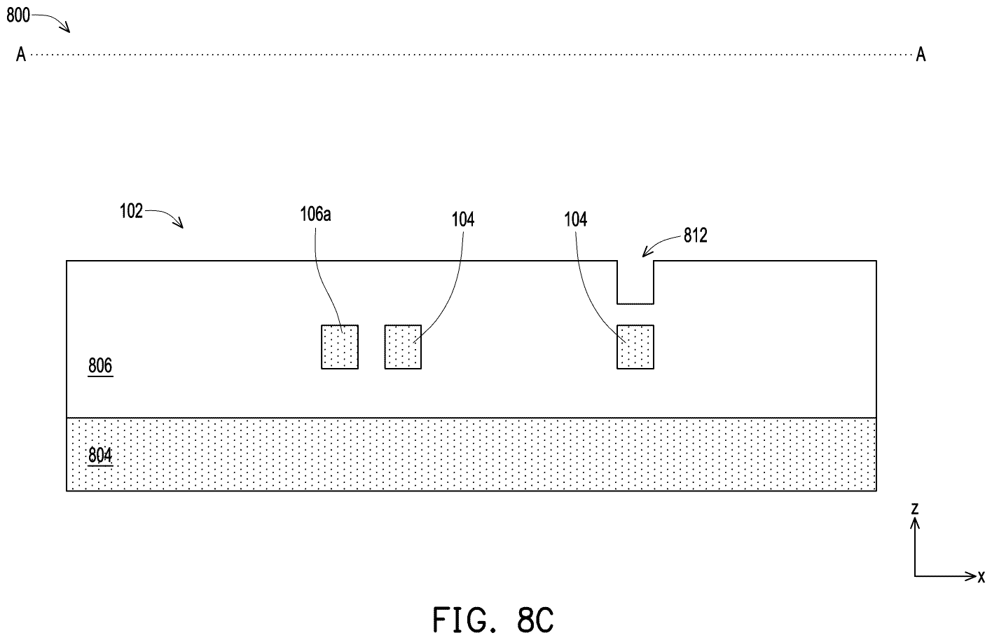

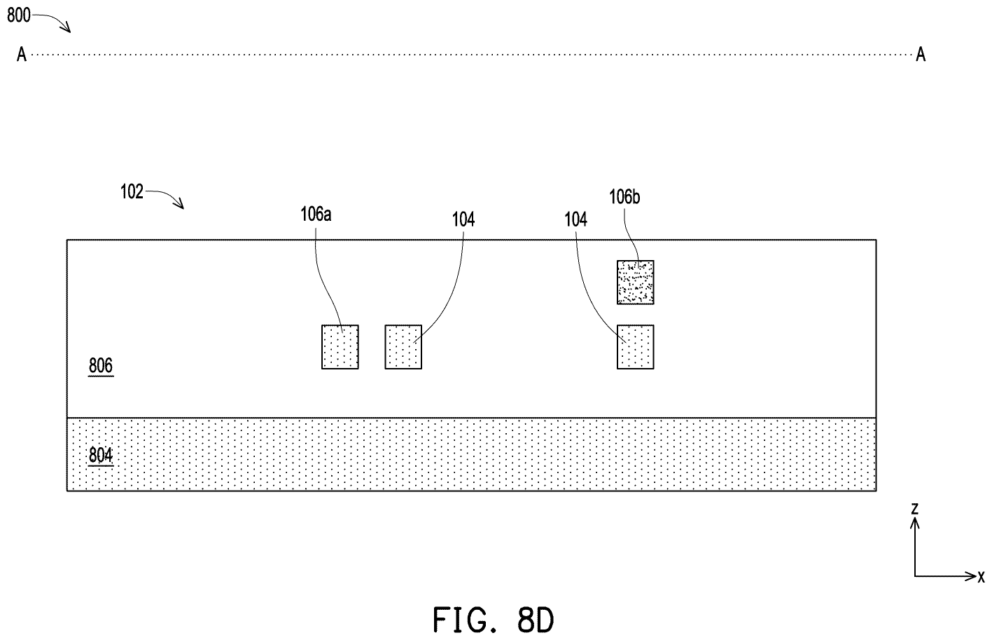

FIGS. 8A-8D are diagrams of an example implementation 800 of forming the semiconductor photonics device 102 (or a portion thereof) described herein. In some implementations, one or more of the semiconductor processing operations described in connection with the example implementation 800 may be performed using one or more of the semiconductor processing tools, such as a deposition tool, an exposure tool, a developer tool, an etch tool, a planarization tool, an ion implantation tool, and/or a wafer/die transport tool, among other examples. In some implementations, one or more of the semiconductor processing operations described in connection with the example implementation 800 may be performed to form one or more of the example implementations of the semiconductor photonics device 102 illustrated and described in connection with FIGS. 1A-1E, 2A-2D, 3A-3E, and/or 4E, among other examples.

Turning to FIG. 8A, a substrate 802 may be provided. The substrate 802 may include a semiconductor substrate 804, a dielectric layer 806, and a semiconductor layer 808, similar to the substrate 502 in the example implementation 500. As further shown in FIG. 8A, a hard mask layer 810 may be formed on the semiconductor layer 808 and patterned similarly to the hard mask layer 510 in the example implementation 500. However, in the example implementation 800, the hard mask layer 810 is patterned for formation of a closed-loop optical waveguide structure 104 and only the bus optical waveguide structure 106a (e.g., not for the bus optical waveguide structure 106b).

As shown in FIG. 8B, an etch tool is used to etch the semiconductor layer 808 to form a closed-loop optical waveguide structure 104 and to form a bus optical waveguide structure 106a adjacent to a first side of the closed-loop optical waveguide structure 104 by removing portions of the semiconductor layer 808 based on the pattern in the hard mask layer 810. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a planarization tool is used to remove the remaining portions of the hard mask layer 810 using a CMP technique and/or another type of planarization technique. The closed-loop optical waveguide structure 104 may be formed to have a polygonal top view shape having a plurality of segments 108 that are connected at interconnection points 110 at opposing ends of the segments 108, as illustrated in the example implementations of the closed-loop optical waveguide structure 104 in FIGS. 1A-1E, 2A-2D, 3A-3E, and/or 4E, among other examples.

As shown in FIG. 8C, additional material for the dielectric layer 806 may be deposited over the closed-loop optical waveguide structure 104 and the bus optical waveguide structure 106a such that the closed-loop optical waveguide structure 104 and the bus optical waveguide structure 106a are encapsulated in the dielectric layer 806. A deposition tool may be used to deposit the additional material for the dielectric layer 806 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 806 after the additional material of the dielectric layer 806 is deposited.

In some implementations, the z-direction distance between the recess 812 and the second side of the closed-loop optical waveguide structure 104, and the x-direction distance between the bus optical waveguide structure 106a and the first side of the closed-loop optical waveguide structure 104, are approximately a same distance. In some implementations, the z-direction distance between the recess 812 and the second side of the closed-loop optical waveguide structure 104, and the x-direction distance between the bus optical waveguide structure 106a and the first side of the closed-loop optical waveguide structure 104, are different distances.

In some implementations, the depth of the recess 812 and the thickness of the bus optical waveguide structure 106a are approximately the same. In some implementations, the depth of the recess 812 and the thickness of the bus optical waveguide structure 106a are different. In some implementations, the width of the recess 812 and the width of the bus optical waveguide structure 106a are approximately a same width. In some implementations, the width of the recess 812 and the width of the bus optical waveguide structure 106a are different widths.

In some implementations, the depth of the recess 812 and the thickness of the closed-loop waveguide structure 104 are approximately the same. In some implementations, the depth of the recess 812 and the thickness of the closed-loop waveguide structure 104 are different. In some implementations, the width of the recess 812 and the width of the closed-loop waveguide structure 104 are approximately a same width. In some implementations, the width of the recess 812 and the width of the closed-loop waveguide structure 104 are different widths.

As further shown in FIG. 8C, a recess 812 may be formed in the dielectric layer 806. The recess 812 is formed above a second side of the closed-loop optical waveguide structure 104 opposing the first side adjacent to which the bus optical waveguide structure 106a was formed. In some implementations, a pattern in a photoresist layer is used to etch the dielectric layer 806 to form the recess 812. In these implementations, a deposition tool may be used to form the photoresist layer on the dielectric layer 806. An exposure tool may be used to expose the photoresist layer to a radiation source to pattern the photoresist layer. A developer tool may be used to develop and remove portions of the photoresist layer to expose the pattern. An etch tool may be used to etch the dielectric layer 806 based on the pattern to form the recess 812 in the dielectric layer 806. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 806 based on a pattern.

As shown in FIG. 8D, dielectric material may be deposited in the recess 812 to form the bus optical waveguide structure 106b in the recess 812. Thus, the bus optical waveguide structure 106b is formed above the second side of the closed-loop optical waveguide structure 104 such that the bus optical waveguide structure 106b is vertically adjacent to the second side of the closed-loop optical waveguide structure 104 in the z-direction. A deposition tool may be used to deposit the dielectric material of the bus optical waveguide structure 106b using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the bus optical waveguide structure 106b after the additional material of the dielectric material of the bus optical waveguide structure 106b is deposited.

As further shown in FIG. 8D, additional material for the dielectric layer 806 may be deposited to encapsulate the bus optical waveguide structure 106b in the dielectric layer 806. A deposition tool may be used to deposit the additional material for the dielectric layer 806 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 806 after the additional material of the dielectric layer 806 is deposited.

As indicated above, FIGS. 8A-8D are provided as an example. Other examples may differ from what is described with regard to FIGS. 8A-8D.

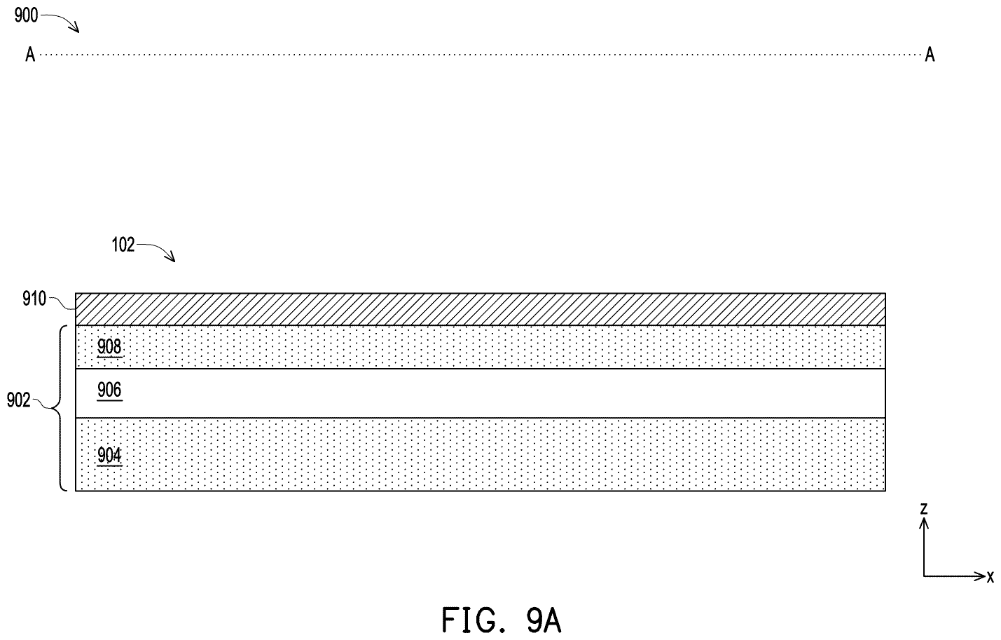

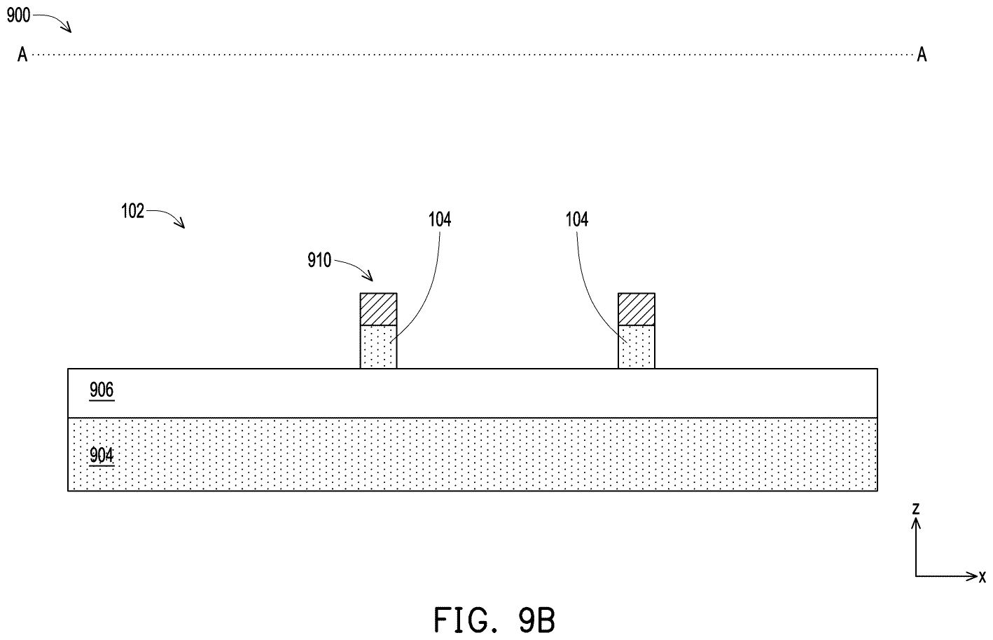

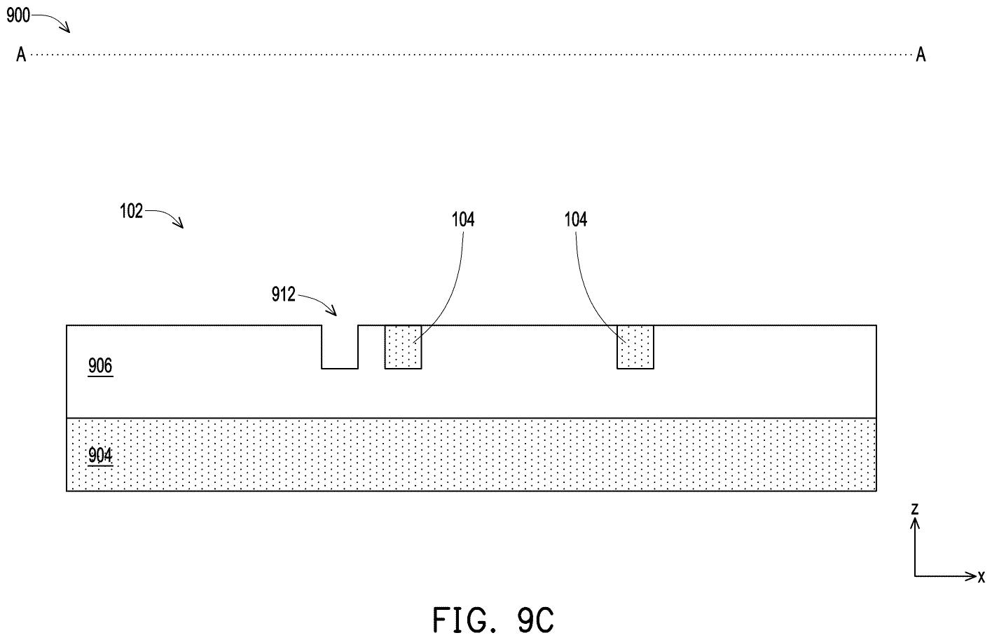

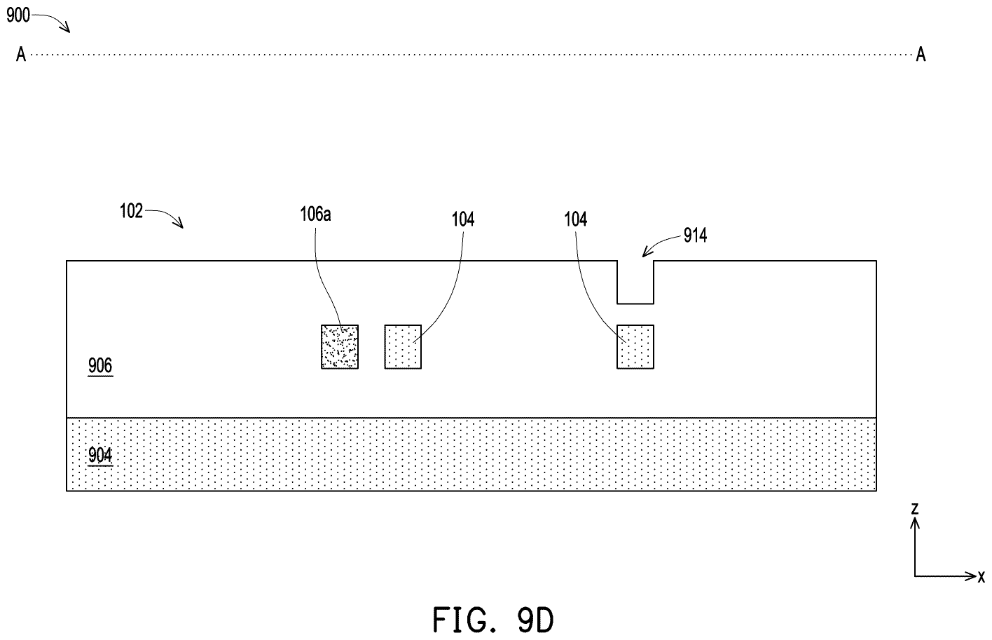

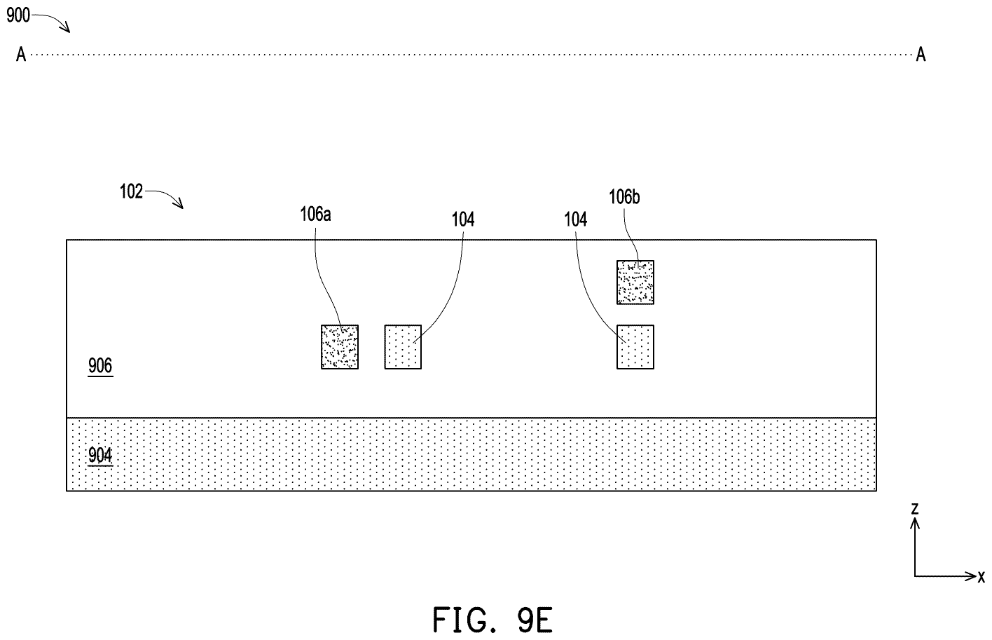

FIGS. 9A-9E are diagrams of an example implementation 900 of forming the semiconductor photonics device 102 (or a portion thereof) described herein. In some implementations, one or more of the semiconductor processing operations described in connection with the example implementation 900 may be performed using one or more of the semiconductor processing tools, such as a deposition tool, an exposure tool, a developer tool, an etch tool, a planarization tool, an ion implantation tool, and/or a wafer/die transport tool, among other examples. In some implementations, one or more of the semiconductor processing operations described in connection with the example implementation 900 may be performed to form one or more of the example implementations of the semiconductor photonics device 102 illustrated and described in connection with FIGS. 1A-1E, 2A-2D, 3A-3E, and/or 4C, among other examples.

Turning to FIG. 9A, a substrate 902 may be provided. The substrate 902 may include a semiconductor substrate 904, a dielectric layer 906, and a semiconductor layer 908, similar to the substrate 502 in the example implementation 500. As further shown in FIG. 9A, a hard mask layer 910 may be formed on the semiconductor layer 908 and patterned similarly to the hard mask layer 510 in the example implementation 500. However, in the example implementation 900, the hard mask layer 910 is patterned for formation only of a closed-loop optical waveguide structure 104 and not for formation of bus optical waveguide structures 106a and 106b.

As shown in FIG. 9B, an etch tool is used to etch the semiconductor layer 908 to form the closed-loop optical waveguide structure 104 by removing portions of the semiconductor layer 908 based on the pattern in the hard mask layer 910. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a planarization tool is used to remove the remaining portions of the hard mask layer 910 using a CMP technique and/or another type of planarization technique. The closed-loop optical waveguide structure 104 may be formed to have a polygonal top view shape having a plurality of segments 108 that are connected at interconnection points 110 at opposing ends of the segments 108, as illustrated in the example implementations of the closed-loop optical waveguide structure 104 in FIGS. 1A-1E, 2A-2D, 3A-3E, and/or 4C, among other examples.

As shown in FIG. 9C, additional material for the dielectric layer 906 may be deposited around the closed-loop optical waveguide structure 104. A deposition tool may be used to deposit the additional material for the dielectric layer 906 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 706 after the additional material of the dielectric layer 906 is deposited.

As further shown in FIG. 9C, a recess 912 may be formed in the dielectric layer 906. The recess 912 may be formed laterally adjacent to a first side of the closed-loop optical waveguide structure 104 in the x-direction. In some implementations, a pattern in a photoresist layer is used to etch the dielectric layer 906 to form the recess 912. In these implementations, a deposition tool may be used to form the photoresist layer on the dielectric layer 906. An exposure tool may be used to expose the photoresist layer to a radiation source to pattern the photoresist layer. A developer tool may be used to develop and remove portions of the photoresist layer to expose the pattern. An etch tool may be used to etch the dielectric layer 906 based on the pattern to form the recess 912 in the dielectric layer 906. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 906 based on a pattern.

As shown in FIG. 9D, dielectric material may be deposited in the recess 912 to form the bus optical waveguide structure 106a laterally adjacent to the first side of the closed-loop optical waveguide structure 104 in the x-direction. A deposition tool may be used to deposit the dielectric material of the bus optical waveguide structure 106a using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the bus optical waveguide structure 106a after the additional material of the dielectric material of the bus optical waveguide structure 106a is deposited.

As further shown in FIG. 9D, additional material for the dielectric layer 906 may be deposited to encapsulate the closed-loop optical waveguide structure 104 and the bus optical waveguide structures 106a in the dielectric layer 906. A deposition tool may be used to deposit the additional material for the dielectric layer 906 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 906 after the additional material of the dielectric layer 906 is deposited.

As further shown in FIG. 9D, a recess 914 may be formed in the dielectric layer 906 after the additional material for the dielectric layer 906 may be deposited to encapsulate the closed-loop optical waveguide structure 104 and the bus optical waveguide structures 106a. The recess 914 is formed above a second side of the closed-loop optical waveguide structure 104 opposing the first side adjacent to which the bus optical waveguide structure 106a was formed. In some implementations, a pattern in a photoresist layer is used to etch the dielectric layer 906 to form the recess 914. In these implementations, a deposition tool may be used to form the photoresist layer on the dielectric layer 906. An exposure tool may be used to expose the photoresist layer to a radiation source to pattern the photoresist layer. A developer tool may be used to develop and remove portions of the photoresist layer to expose the pattern. An etch tool may be used to etch the dielectric layer 906 based on the pattern to form the recess 912 in the dielectric layer 906. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 906 based on a pattern.

As shown in FIG. 9E, dielectric material may be deposited in the recess 914 to form the bus optical waveguide structure 106b in the recess 914. Thus, the bus optical waveguide structure 106b is formed above the second side of the closed-loop optical waveguide structure 104 such that the bus optical waveguide structure 106b is vertically adjacent to the second side of the closed-loop optical waveguide structure 104 in the z-direction. A deposition tool may be used to deposit the dielectric material of the bus optical waveguide structure 106b using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the bus optical waveguide structure 106b after the additional material of the dielectric material of the bus optical waveguide structure 106b is deposited.

As further shown in FIG. 9E, additional material for the dielectric layer 906 may be deposited to encapsulate the bus optical waveguide structure 106b in the dielectric layer 906. A deposition tool may be used to deposit the additional material for the dielectric layer 906 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 906 after the additional material of the dielectric layer 906 is deposited.

As indicated above, FIGS. 9A-9E are provided as an example. Other examples may differ from what is described with regard to FIGS. 9A-9E.

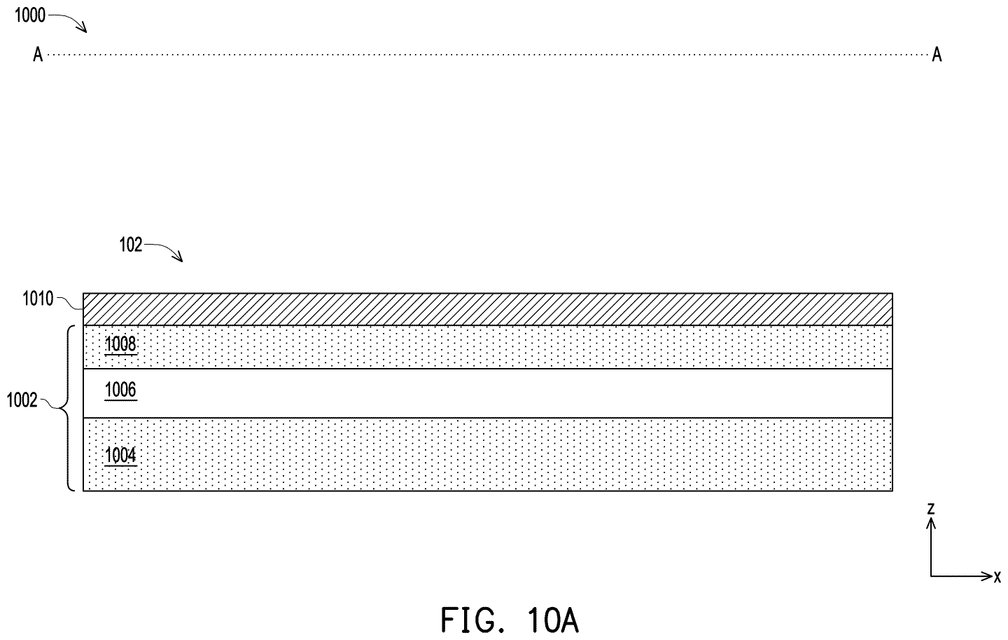

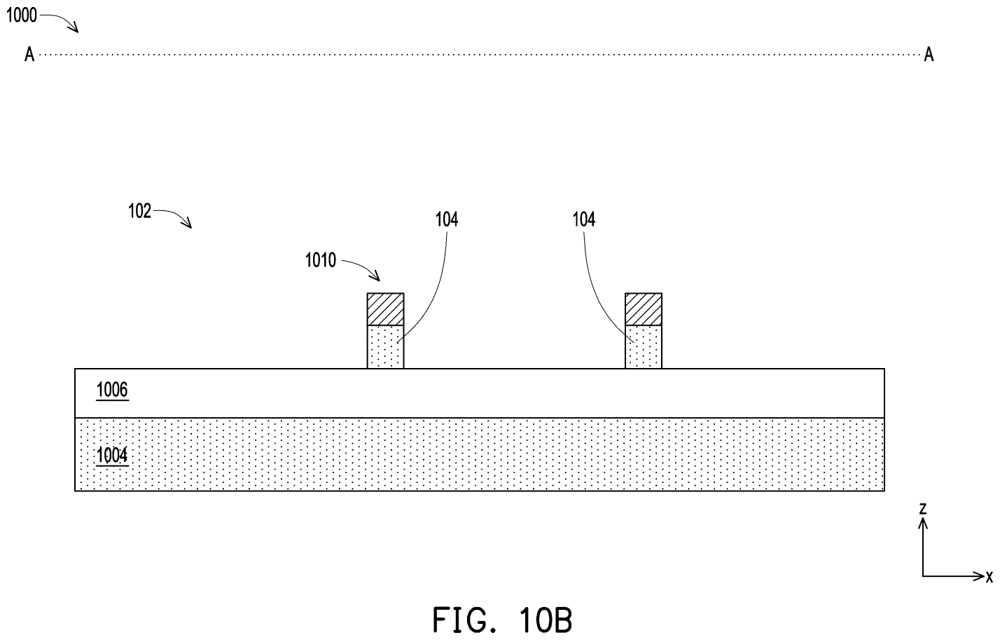

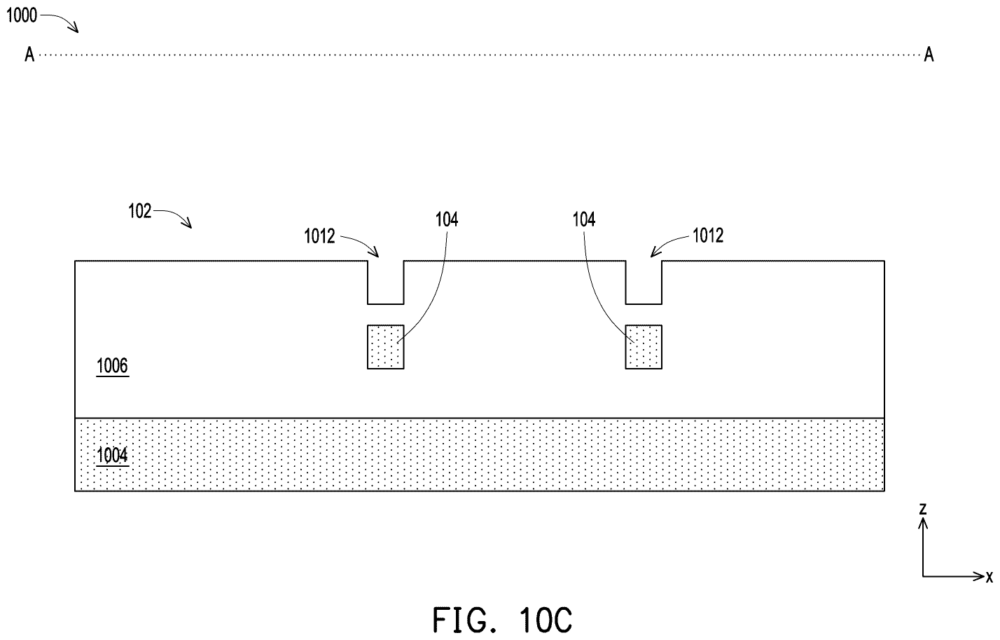

FIGS. 10A-10D are diagrams of an example implementation 1000 of forming the semiconductor photonics device 102 (or a portion thereof) described herein. In some implementations, one or more of the semiconductor processing operations described in connection with the example implementation 1000 may be performed using one or more of the semiconductor processing tools, such as a deposition tool, an exposure tool, a developer tool, an etch tool, a planarization tool, an ion implantation tool, and/or a wafer/die transport tool, among other examples. In some implementations, one or more of the semiconductor processing operations described in connection with the example implementation 1000 may be performed to form one or more of the example implementations of the semiconductor photonics device 102 illustrated and described in connection with FIGS. 1A-1E, 2A-2D, 3A-3E, and/or 4A, among other examples.

Turning to FIG. 10A, a substrate 1002 may be provided. The substrate 1002 may include a semiconductor substrate 1004, a dielectric layer 1006, and a semiconductor layer 1008, similar to the substrate 502 in the example implementation 500. As further shown in FIG. 10A, a hard mask layer 1010 may be formed on the semiconductor layer 1008 and patterned similarly to the hard mask layer 510 in the example implementation 500. However, in the example implementation 1000, the hard mask layer 1010 is patterned for formation only of a closed-loop optical waveguide structure 104 (e.g., and not for formation of bus optical waveguide structures 106a and 106b).

As shown in FIG. 10B, an etch tool is used to etch the semiconductor layer 1008 to form a closed-loop optical waveguide structure 104 by removing portions of the semiconductor layer 1008 based on the pattern in the hard mask layer 1010. In some implementations, the etch operation includes a plasma etch operation, a wet chemical etch operation, and/or another type of etch operation. In some implementations, a photoresist removal tool removes the remaining portions of the photoresist layer (e.g., using a chemical stripper, plasma ashing, and/or another technique). In some implementations, a planarization tool is used to remove the remaining portions of the hard mask layer 1010 using a CMP technique and/or another type of planarization technique. The closed-loop optical waveguide structure 104 may be formed to have a polygonal top view shape having a plurality of segments 108 that are connected at interconnection points 110 at opposing ends of the segments 108, as illustrated in the example implementations of the closed-loop optical waveguide structure 104 in FIGS. 1A-1E, 2A-2D, 3A-3E, and/or 4A, among other examples.

As shown in FIG. 10C, additional material for the dielectric layer 1006 may be deposited over the closed-loop optical waveguide structure 104 such that the closed-loop optical waveguide structure 104 and the bus optical waveguide structure are encapsulated in the dielectric layer 1006. A deposition tool may be used to deposit the additional material for the dielectric layer 1006 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 1006 after the additional material of the dielectric layer 1006 is deposited.

As further shown in FIG. 10C, a plurality of recesses 1012 may be formed in the dielectric layer 1006. A first recess 1012 is formed above a first side of the closed-loop optical waveguide structure 104. A second recess 1012 is formed above a second side of the closed-loop optical waveguide structure 104 opposing the first side above which the first recess 1012 is formed. In some implementations, a pattern in a photoresist layer is used to etch the dielectric layer 1006 to form the recesses 1012. In these implementations, a deposition tool may be used to form the photoresist layer on the dielectric layer 1006. An exposure tool may be used to expose the photoresist layer to a radiation source to pattern the photoresist layer. A developer tool may be used to develop and remove portions of the photoresist layer to expose the pattern. An etch tool may be used to etch the dielectric layer 1006 based on the pattern to form the recesses 1012 in the dielectric layer 1006. In some implementations, the etch operation includes a plasma etch operation, a wet chemical etch operation, and/or another type of etch operation. In some implementations, a photoresist removal tool may be used to remove the remaining portions of the photoresist layer (e.g., using a chemical stripper, plasma ashing, and/or another technique). In some implementations, a hard mask layer is used as an alternative technique for etching the dielectric layer 1006 based on a pattern.

In some implementations, the distance between the first recess 1012 and the first side of the closed-loop optical waveguide structure 104, and the distance between the second recess 1012 and the second side of the closed-loop optical waveguide structure 104, are approximately a same distance. In some implementations, the distance between the first recess 1012 and the first side of the closed-loop optical waveguide structure 104, and the distance between the second recess 1012 and the second side of the closed-loop optical waveguide structure 104, are different distances.

In some implementations, the depth of the first recess 1012 and the depth of the second recess 1012 are approximately a same depth. In some implementations, the depth of the first recess 1012 and the depth of the second recess 1012 are different depths. In some implementations, the width of the first recess 1012 and the width of the second recess 1012 are approximately a same width. In some implementations, the width of the first recess 1012 and the width of the second recess 1012 are different widths.

In some implementations, the depth of the first recess 1012 and the thickness of the closed-loop waveguide structure 104 are approximately the same. In some implementations, the depth of the first recess 1012 and the thickness of the closed-loop waveguide structure 104 are different. In some implementations, the width of the first recess 1012 and the width of the closed-loop waveguide structure 104 are approximately a same width. In some implementations, the width of the first recess 1012 and the width of the closed-loop waveguide structure 104 are different widths.

In some implementations, the depth of the second recess 1012 and the thickness of the closed-loop waveguide structure 104 are approximately the same. In some implementations, the depth of the second recess 1012 and the thickness of the closed-loop waveguide structure 104 are different. In some implementations, the width of the second recess 1012 and the width of the closed-loop waveguide structure 104 are approximately a same width. In some implementations, the width of the second recess 1012 and the width of the closed-loop waveguide structure 104 are different widths.

As shown in FIG. 10D, dielectric material may be deposited in the recesses 1012 to form the bus optical waveguide structures 106a and 106b. Dielectric material may be deposited in the first recess 1012 to form the bus optical waveguide structure 106a above the first side of the closed-loop optical waveguide structure 104 such that the bus optical waveguide structure 106a is vertically adjacent to the first side of the closed-loop optical waveguide structure 104 in the z-direction. Dielectric material may be deposited in the second recess 1012 to form the bus optical waveguide structure 106b above the second side of the closed-loop optical waveguide structure 104 such that the bus optical waveguide structure 106b is vertically adjacent to the second side (e.g., opposing the first side) of the closed-loop optical waveguide structure 104 in the z-direction. A deposition tool may be used to deposit the dielectric material of the bus optical waveguide structures 106a and 106b using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the bus optical waveguide structures 106a and 106b after the additional material of the dielectric material of the bus optical waveguide structures 106a and 106b are deposited.

As further shown in FIG. 10D, additional material for the dielectric layer 1006 may be deposited to encapsulate the bus optical waveguide structures 106a and 106b in the dielectric layer 1006. A deposition tool may be used to deposit the additional material for the dielectric layer 1006 using a CVD technique, a PVD technique, an oxidation technique (e.g., a thermal oxidation technique), and/or another type of deposition technique. In some implementations, a planarization tool may be used to perform a CMP operation and/or another type of planarization operation to planarize the dielectric layer 1006 after the additional material of the dielectric layer 1006 is deposited.

As indicated above, FIGS. 10A-10D are provided as an example. Other examples may differ from what is described with regard to FIGS. 10A-10D.

FIGS. 11A-11C are diagrams of example implementations of cross-sectional profiles for one or more waveguides structures described herein. A closed-loop optical waveguide structure 104 described herein and/or a bus optical waveguide structure 106 (e.g., a bus optical waveguide structure 106a, a bus optical waveguide structure 106b) described herein may be manufactured to have one or more of the example implementations of cross-sectional profiles illustrated in FIGS. 11A-11C. In some implementations, a closed-loop optical waveguide structure 104 described herein and/or a bus optical waveguide structure 106 (e.g., a bus optical waveguide structure 106a, a bus optical waveguide structure 106b) described herein may be manufactured to have another cross-sectional profile.

FIG. 11A illustrates an example implementation 1100 of a cross-sectional profile of a closed-loop optical waveguide structure 104. The cross-sectional profile in FIG. 11A may be referred to as a strip waveguide. The strip waveguide has a square-shaped cross-sectional profile or rectangle-shaped cross-sectional profile and includes a strip of semiconductor material or dielectric material. The strip waveguide may be formed above a semiconductor substrate 1102 (which may correspond to the semiconductor substrate 504, 604, 704, 804, 904, and/or 1004, among other examples) and on a dielectric layer 1104 (which may correspond to the dielectric layer 402, 506, 606, 706, 806, 906, and/or 1006, among other examples).

FIG. 11B illustrates an example implementation 1106 of a cross-sectional profile of a closed-loop optical waveguide structure 104. The cross-sectional profile in FIG. 11B may be referred to as a rib waveguide. The rib waveguide includes a strip section 1108 on top of a planar section 1110, where the planar section extends laterally outward past the strip section 1108 in the x-direction on opposing sides of the strip section 1108. In some implementations, an extension section 1112 may also be included on the planar section 1110 and adjacent to the strip section 1108. The extension section 1112 may include the same material(s) and/or material composition as the strip section 1108. Alternatively, the extension section 1112 and the strip section 1108 may include different material(s) and/or different material compositions.

FIG. 11C illustrates an example implementation 1114 of a cross-sectional profile of a closed-loop optical waveguide structure 104. The cross-sectional profile in FIG. 11C may be referred to as a deep rib waveguide. The deep rib waveguide includes a strip section 1108 on top of a planar section 1110, where the planar section extends laterally outward past the strip section 1108 in the x-direction on opposing sides of the strip section 1108. The difference between the deep rib waveguide cross-sectional profile illustrated in FIG. 11C and the rib waveguide cross-sectional profile illustrated in FIG. 11B is that the difference between the thickness of the strip section 1108 and the thickness of the planar section 1110 in the deep rib waveguide cross-sectional profile illustrated in FIG. 11C is less than the difference between the thickness of the strip section 1108 and the thickness of the planar section 1110 in the rib waveguide cross-sectional profile illustrated in FIG. 11B. The thickness of the planar section 1110 in the deep rib waveguide cross-sectional profile illustrated in FIG. 11C may be greater than the thickness of the planar section 1110 in the rib waveguide cross-sectional profile illustrated in FIG. 10B, and/or the thickness of the strip section 1108 in the deep rib waveguide cross-sectional profile illustrated in FIG. 11C may be less than the thickness of the strip section 1108 in the rib waveguide cross-sectional profile illustrated in FIG. 11B.

As indicated above, FIGS. 11A-11C are provided as examples. Other examples may differ from what is described with regard to FIGS. 11A-11C.

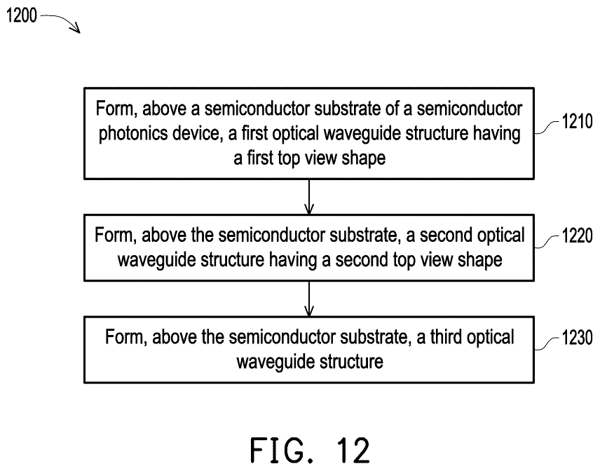

FIG. 12 is a flowchart of an example process 1200 associated with forming a semiconductor photonics device described herein. In some implementations, one or more process blocks of FIG. 12 are performed using one or more semiconductor processing tools, such as a deposition tool, an exposure tool, a developer tool, an etch tool, a planarization tool, an ion implantation tool, and/or a wafer/die transport tool, among other examples.

As shown in FIG. 12, process 1200 may include forming, above a semiconductor substrate of a semiconductor photonics device, a first optical waveguide structure having a first top view shape (block 1210). For example, one or more semiconductor processing tools may be used to form, above a semiconductor substrate (e.g., a semiconductor substrate 504, 504, 704, 804, 904, and/or 1004) of a semiconductor photonics device 102, a first optical waveguide structure (e.g., a bus optical waveguide structure 106a) that has a first top view shape, as described herein.

As further shown in FIG. 12, process 1200 may include forming, above the semiconductor substrate, a second optical waveguide structure having a second top view shape (block 1220). For example, one or more semiconductor processing tools may be used to form, above the semiconductor substrate, a second optical waveguide structure (e.g., a bus optical waveguide structure 106b) that has a second top view shape, as described herein.

As further shown in FIG. 12, process 1200 may include forming, above the semiconductor substrate, a third optical waveguide structure (block 1230). For example, one or more of the semiconductor processing tools may be used to form, above the semiconductor substrate, a third optical waveguide structure (e.g., a closed-loop optical waveguide structure 104), as described herein. In some implementations, the third optical waveguide structure (e.g., the closed-loop optical waveguide structure 104) is between the first optical waveguide structure (e.g., the bus optical waveguide structure 106a) and the second optical waveguide structure (e.g., the bus optical waveguide structure 106b). In some implementations, the third optical waveguide structure (e.g., the closed-loop optical waveguide structure 104) has a third top view shape having a plurality of segments 108. The segments 108 may be connected at interconnection points 110 at opposing ends of the segments 108.

Process 1200 may include additional implementations, such as any single implementation or any combination of implementations described below and/or in connection with one or more other processes described elsewhere herein.

In a first implementation, forming the optical waveguide structure (e.g., the bus optical waveguide structure 106a) includes forming the first optical waveguide structure (e.g., the bus optical waveguide structure 106a) from a semiconductor layer 508 that is above the semiconductor substrate, forming the second optical waveguide structure (e.g., the bus optical waveguide structure 106b) includes forming the second optical waveguide structure (e.g., the bus optical waveguide structure 106b) structure from the semiconductor layer 508, and forming the third optical waveguide structure (e.g., the closed-loop optical waveguide structure 104) includes forming the third optical waveguide structure (e.g., the closed-loop optical waveguide structure 104) from the semiconductor layer 508.

In a second implementation, alone or in combination with the first implementation, forming the first optical waveguide structure (e.g., the bus optical waveguide structure 106a) includes forming the first optical waveguide structure (e.g., the bus optical waveguide structure 106a) from a semiconductor layer 608 that is above the semiconductor substrate, forming the third optical waveguide structure (e.g., the closed-loop optical waveguide structure 104) includes forming the third optical waveguide structure (e.g., the closed-loop optical waveguide structure 104) from the semiconductor layer 608, and forming the second optical waveguide structure (e.g., the bus optical waveguide structure 106b) includes depositing, in a recess 612 that is horizontally adjacent to the third optical waveguide structure (e.g., the closed-loop optical waveguide structure 104), dielectric material to form the second optical waveguide structure (e.g., the bus optical waveguide structure 106b).

In a third implementation, alone or in combination with one or more of the first and second implementations, forming the third optical waveguide structure (e.g., the closed-loop optical waveguide structure 104) includes forming the third optical waveguide structure (e.g., the closed-loop optical waveguide structure 104) from a semiconductor layer 708 that is above the semiconductor substrate, forming the first optical waveguide structure (e.g., the bus optical waveguide structure 106a) includes depositing, in a first recess 712 that is horizontally adjacent to a first side of the third optical waveguide structure (e.g., the closed-loop optical waveguide structure 104), dielectric material to form the first optical waveguide structure (e.g., the bus optical waveguide structure 106a), and forming the second optical waveguide structure (e.g., the bus optical waveguide structure 106b) includes depositing, in a second recess 712 that is horizontally adjacent to a second side of the third optical waveguide structure (e.g., the closed-loop optical waveguide structure 104) opposing the first side, dielectric material to form the second optical waveguide structure (e.g., the bus optical waveguide structure 106b).

In a fourth implementation, alone or in combination with one or more of the first through third implementations, forming the first optical waveguide structure (e.g., the bus optical waveguide structure 106a) includes forming the first optical waveguide structure (e.g., the bus optical waveguide structure 106a) from a semiconductor layer 808 that is above the semiconductor substrate, forming the third optical waveguide structure (e.g., the closed-loop optical waveguide structure 104) includes forming the third optical waveguide structure (e.g., the closed-loop optical waveguide structure 104) from the semiconductor layer, and forming the second optical waveguide structure (e.g., the bus optical waveguide structure 106b) includes depositing, in a recess 812 that is vertically adjacent to the third optical waveguide structure (e.g., the closed-loop optical waveguide structure 104), dielectric material to form the second optical waveguide structure (e.g., the bus optical waveguide structure 106b).

In a fifth implementation, alone or in combination with one or more of the first through fourth implementations, forming the third optical waveguide structure (e.g., the closed-loop optical waveguide structure 104) includes forming the third optical waveguide structure (e.g., the closed-loop optical waveguide structure 104) from a semiconductor layer 908 that is above the semiconductor substrate, forming the first optical waveguide structure (e.g., the bus optical waveguide structure 106a) includes depositing, in a first recess 912 that is horizontally adjacent to a first side of the third optical waveguide structure (e.g., the closed-loop optical waveguide structure 104), dielectric material to form the first optical waveguide structure (e.g., the bus optical waveguide structure 106a), and forming the second optical waveguide structure (e.g., the bus optical waveguide structure 106b) includes depositing, in a second recess 914 that is vertically adjacent to a second side of the third optical waveguide structure (e.g., the closed-loop optical waveguide structure 104) opposing the first side, dielectric material to form the second optical waveguide structure (e.g., the bus optical waveguide structure 106b).

In a sixth implementation, alone or in combination with one or more of the first through fifth implementations, forming the third optical waveguide structure (e.g., the closed-loop optical waveguide structure 104) includes forming the third optical waveguide structure (e.g., the closed-loop optical waveguide structure 104) from a semiconductor layer 1008 that is above the semiconductor substrate, forming the first optical waveguide structure (e.g., the bus optical waveguide structure 106a) includes depositing, in a first recess 1012 that is vertically adjacent to a first side of the third optical waveguide structure (e.g., the closed-loop optical waveguide structure 104), dielectric material to form the first optical waveguide structure (e.g., the bus optical waveguide structure 106a), and forming the second optical waveguide structure (e.g., the bus optical waveguide structure 106b) includes depositing, in a second recess 1012 that is vertically adjacent to a second side of the third optical waveguide structure (e.g., the closed-loop optical waveguide structure 104) opposing the first side, dielectric material to form the second optical waveguide structure (e.g., the bus optical waveguide structure 106b).

Although FIG. 12 shows example blocks of process 1200, in some implementations, process 1200 includes additional blocks, fewer blocks, different blocks, or differently arranged blocks than those depicted in FIG. 12. Additionally, or alternatively, two or more of the blocks of process 1200 may be performed in parallel.

In this way, a semiconductor photonics device includes a plurality of bus optical waveguide structures and one or more closed-loop optical waveguide structures that are arranged in a cascaded photonic integrated circuit such as a cascaded resonator circuit. At least one of the closed-loop optical waveguide structures is manufactured to have a polygonal top view shape in which the closed-loop optical waveguide structure includes a plurality of segments. This enables the intrinsic loss for the closed-loop optical waveguide structure to be tuned to achieve optical loss matching in the photonic integrated circuit.

As described in greater detail above, some implementations described herein provide a semiconductor photonics device. The semiconductor photonics device includes a first optical waveguide structure. The semiconductor photonics device includes a second optical waveguide structure. The semiconductor photonics device includes a third optical waveguide structure, between the first optical waveguide structure and the second optical waveguide structure, having a top view shape having a plurality of segments.

As described in greater detail above, some implementations described herein provide a semiconductor photonics device. The semiconductor photonics device includes a first optical waveguide structure having a first top view shape having a plurality of first segments. The semiconductor photonics device includes a second optical waveguide structure having a second top view shape having a plurality of second segments. The semiconductor photonics device includes a third optical waveguide structure, between the first optical waveguide structure and the second optical waveguide structure, having a third top view shape having a plurality of third segments.

As described in greater detail above, some implementations described herein provide a method. The method includes forming, above a semiconductor substrate of a semiconductor photonics device, a first optical waveguide structure having a first top view shape. The method includes forming, above the semiconductor substrate, a second optical waveguide structure having a second top view shape. The method includes forming, above the semiconductor substrate, a third optical waveguide structure, where the third optical waveguide structure is between the first optical waveguide structure and the second optical waveguide structure, and where the third optical waveguide structure has a third top view shape having a plurality of segments.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

The terms “approximately” and “substantially” can indicate a value of a given quantity that varies within 5% of the value (e.g., ±1%, ±2%, ±3%, ±4%, ±5% of the value). These values are merely examples and are not intended to be limiting. It is to be understood that the terms “approximately” and “substantially” can refer to a percentage of the values of a given quantity in light of this disclosure.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A semiconductor photonics device, comprising:
a first optical waveguide structure; and
a second optical waveguide structure; and
a third optical waveguide structure, between the first optical waveguide structure and the second optical waveguide structure, comprising a top view shape having a plurality of segments.

2. The semiconductor photonics device of claim 1, wherein a first segment, of the plurality of segments, at a first side of the third optical waveguide structure is adjacent to the first optical waveguide structure; and
wherein a second segment, of the plurality of segments, at a second side of the third optical waveguide structure is adjacent to the second optical waveguide structure,
wherein the first side and the second side are opposing sides of the third optical waveguide structure.

3. The semiconductor photonics device of claim 1, wherein the third optical waveguide structure is a first closed-loop optical waveguide structure in the semiconductor photonics device, comprising a first top view shape having a first plurality of segments; and
wherein the semiconductor photonics device further comprises:
a second closed-loop optical waveguide structure, adjacent to the first closed-loop optical waveguide structure, comprising a second top view shape having a second plurality of segments.

4. The semiconductor photonics device of claim 3, wherein the first top view shape and the second top view shape are different top view shapes.

5. The semiconductor photonics device of claim 3, wherein the first closed-loop optical waveguide structure is adjacent to the first optical waveguide structure;
wherein the second closed-loop optical waveguide structure is adjacent to the second optical waveguide structure; and
wherein the second closed-loop optical waveguide structure is between the first closed-loop optical waveguide structure and the second optical waveguide structure.

6. The semiconductor photonics device of claim 3, wherein the first closed-loop optical waveguide structure is adjacent to the first optical waveguide structure at a first side of the first closed-loop optical waveguide structure and is adjacent to the second optical waveguide structure at a second side of the first closed-loop optical waveguide structure opposing the first side of the first closed-loop optical waveguide structure; and
wherein the second closed-loop optical waveguide structure is adjacent to the first optical waveguide structure at a first side of the second closed-loop optical waveguide structure and is adjacent to the second optical waveguide structure at a second side of the second closed-loop optical waveguide structure opposing the first side of the second closed-loop optical waveguide structure.

7. The semiconductor photonics device of claim 1, wherein the third optical waveguide structure is a first closed-loop optical waveguide structure in the semiconductor photonics device; and
wherein the semiconductor photonics device further comprises:
a second closed-loop optical waveguide structure, adjacent to the first closed-loop optical waveguide structure, comprising a ring-shaped top view shape.

8. The semiconductor photonics device of claim 1, wherein the first optical waveguide structure and the second optical waveguide structure have different material compositions.

9. The semiconductor photonics device of claim 8, wherein the first optical waveguide structure comprises a semiconductor material; and
wherein second optical waveguide structure comprises a dielectric material.

10. A semiconductor photonics device, comprising:
a first optical waveguide structure comprising a first top view shape having a plurality of first segments; and
a second optical waveguide structure comprising a second top view shape having a plurality of second segments; and
a third optical waveguide structure, between the first optical waveguide structure and the second optical waveguide structure, comprising a third top view shape having a plurality of third segments.

11. The semiconductor photonics device of claim 10, wherein the first top view shape and the second top view shape are each approximately symmetrical with at least a portion of the third top view shape.

12. The semiconductor photonics device of claim 10, wherein the first top view shape and the second top view shape are approximately mirrored top view shapes.

13. The semiconductor photonics device of claim 10, wherein the third optical waveguide structure is a first closed-loop optical waveguide structure, the semiconductor photonics device further comprising:
a second closed-loop optical waveguide structure between the first closed-loop optical waveguide structure and the second optical waveguide structure,
wherein the second closed-loop optical waveguide structure comprises a fourth view shape having a plurality of fourth segments.

14. A method, comprising:
forming, above a semiconductor substrate of a semiconductor photonics device, a first optical waveguide structure comprising a first top view shape;
forming, above the semiconductor substrate, a second optical waveguide structure comprising a second top view shape; and
forming, above the semiconductor substrate, a third optical waveguide structure,
wherein the third optical waveguide structure is between the first optical waveguide structure and the second optical waveguide structure, and
wherein the third optical waveguide structure comprises a third top view shape having a plurality of segments.

15. The method of claim 14, wherein forming the first optical waveguide structure comprises:
forming the first optical waveguide structure from a semiconductor layer that is above the semiconductor substrate;
wherein forming the second optical waveguide structure comprises:
forming the second optical waveguide structure from the semiconductor layer; and
wherein forming the third optical waveguide structure comprises:
forming the third optical waveguide structure from the semiconductor layer.

16. The method of claim 14, wherein forming the first optical waveguide structure comprises:
forming the first optical waveguide structure from a semiconductor layer that is above the semiconductor substrate;
wherein forming the third optical waveguide structure comprises:
forming the third optical waveguide structure from the semiconductor layer; and
wherein forming the second optical waveguide structure comprises:
depositing, in a recess horizontally adjacent to the third optical waveguide structure, dielectric material to form the second optical waveguide structure.

17. The method of claim 14, wherein forming the third optical waveguide structure comprises:
forming the third optical waveguide structure from a semiconductor layer that is above the semiconductor substrate;
wherein forming the first optical waveguide structure comprises:
depositing, in a first recess horizontally adjacent to a first side of the third optical waveguide structure, dielectric material to form the first optical waveguide structure; and
wherein forming the second optical waveguide structure comprises:
depositing, in a second recess horizontally adjacent to a second side of the third optical waveguide structure opposing the first side, dielectric material to form the second optical waveguide structure.

18. The method of claim 14, wherein forming the first optical waveguide structure comprises:
forming the first optical waveguide structure from a semiconductor layer that is above the semiconductor substrate;
wherein forming the third optical waveguide structure comprises:
forming the third optical waveguide structure from the semiconductor layer; and
wherein forming the second optical waveguide structure comprises:
depositing, in a recess vertically adjacent to the third optical waveguide structure, dielectric material to form the second optical waveguide structure.

19. The method of claim 14, wherein forming the third optical waveguide structure comprises:
forming the third optical waveguide structure from a semiconductor layer that is above the semiconductor substrate;
wherein forming the first optical waveguide structure comprises:
depositing, in a first recess horizontally adjacent to a first side of the third optical waveguide structure, dielectric material to form the first optical waveguide structure; and
wherein forming the second optical waveguide structure comprises:
depositing, in a second recess vertically adjacent to a second side of the third optical waveguide structure opposing the first side, dielectric material to form the second optical waveguide structure.

20. The method of claim 14, wherein forming the third optical waveguide structure comprises:
forming the third optical waveguide structure from a semiconductor layer that is above the semiconductor substrate;
wherein forming the first optical waveguide structure comprises:
depositing, in a first recess vertically adjacent to a first side of the third optical waveguide structure, dielectric material to form the first optical waveguide structure; and
wherein forming the second optical waveguide structure comprises:
depositing, in a second recess vertically adjacent to a second side of the third optical waveguide structure opposing the first side, dielectric material to form the second optical waveguide structure.
